(19) United States
(12) Patent Application Publication
(10) Pub. No.: US 2001/0012008 A1
(43) Pub. Date: Aug. 9, 2001

(54) APPARATUS AND METHOD FOR MANAGING SCHEDULE, AND COMPUTER-READABLE STORAGE MEDIUM STORING SCHEDULE MANAGEMENT PROGRAM

(76) Inventor: TADASHI HONGAWA, KAWASAKI-SHI (JP)

Correspondence Address: STAAS & HALSEY LLP, 700 11TH STREET, NW, SUITE 500, WASHINGTON, DC, 20001, US

(21) Appl. No.: 09/090,843

(22) Filed: Jun. 4, 1998

(30) Foreign Application Priority Data
Oct. 30, 1997 (JP) 09-298457

(51) Int. Cl. G09G 5/00

(52) U.S. Cl. 345/418

(57) ABSTRACT

An input process unit selects one or more target items. A scale computing unit automatically scales a display period based on the size of the screen such that all selected items can be completely displayed on the screen. When the start and the end of the display period are specified, the display period can be automatically scaled based on the size of the screen.

### BACKGROUND OF THE INVENTION

1. Field of the Invention

The present invention relates to an apparatus and a method for managing a schedule by displaying the layout of items indicating on a schedule chart the time required for each process in a schedule management using a computer, and to a computer-readable storage medium for storing a program for use in managing the schedule.

2. Description of the Related Art

The computer can be used in schedule management. In the schedule management, a target (hereinafter referred to as an item) such as an operation, etc. to be scheduled in a given period is appropriately laid out and displayed on a schedule chart. The display period of a conventional schedule chart has been shown in given size as specified by the day, week, month, etc. When the display period is to be amended, the screen is scrolled to display data at a specified position using a scroll bar, etc.

In the conventional schedule management apparatus, there have been the following problems from the restrictions on the size of a display screen when an item indicating the period of an operation is displayed on a schedule chart.

(1) Conventionally, it is necessary to manually scroll a display area until a target item can be appropriately displayed on the screen so that the target item can be confirmed on the screen.

(2) When the target item covers a long period, the size of the entire schedule chart must be manually scaled down.

(3) Since the display area can be continuously moved by scrolling the schedule chart, it is an irksome operation to get back to the previously displayed area.

(4) When a long-term schedule is completely displayed on a screen, the entire schedule chart can be scaled down. However, in this method, a target item is displayed in scaled-down size as one of a large number of items in the schedule chart, and cannot be easily located.

(5) When a target item should be clearly displayed in large size, the entire schedule chart should be scaled up, and then the schedule chart is scrolled until the target item can be displayed at an appropriate position on the screen.

### SUMMARY OF THE INVENTION

The present invention aims at providing an apparatus and a method for managing a schedule in such a way that a target portion in a schedule chart can be easily located by a simple operation, and also providing a computer-readable storage medium storing a schedule management program.

The schedule management apparatus according to the present invention includes an item selection unit, a display period scaling unit, a display period selection unit, a central display target specification unit, a central display adjustment unit, a scaled-up target display specification unit, a scaled-up target display adjustment unit, a scale-up/scale-down position specification unit, a specified position scale-up/scale-down unit, an input process unit, and a scale computing unit.

According to the first aspect of the present invention, the item selection unit selects one or more target items. The display period scaling unit automatically scales the display period with reference to the screen size in such a way that all selected items can be completely displayed on the screen.

According to the second aspect of the present invention, the display period selection unit specifies the start and the end of the display period. The display period scaling unit automatically scales the display period with reference to the screen size in such a way that specified display period can be completely displayed on the screen.

According to the third aspect of the present invention, the central display target specification unit specifies the current date, period, or item. The central display adjustment unit adjusts the start and the end of the display period such that the specified current date, period, or item can be positioned in the center of the display period.

According to the fourth aspect of the present invention, the scaled-up target display specification unit specifies a target date, period, or item. The scaled-up target display adjustment unit adjusts the display intervals of the unit of period in the display period such that the period containing the specified date, the specified period, or the period containing the specified item can be larger than other periods.

According to the fifth aspect of the present invention, the scale-up/scale-down position specification unit specifies a position in the schedule chart. The specified position scale-up/scale-down unit scales up or down the display period with reference to the specified position.

According to the sixth aspect of the present invention, the input process unit selects an item specified by the input device. The scale computing unit computes the scale of the schedule chart for redisplay according to the information about the item selected by the input process unit.

### BRIEF DESCRIPTION OF THE DRAWINGS

The present invention will be more apparent from the following detailed description when taken in conjunction with the accompanying drawings, in which;

FIG. 1 shows an example of the configuration of the block according to the present invention;

FIG. 2A shows an example of the data structure of the schedule chart;

FIG. 2B shows an example of the data structure of the coordinate conversion table;

FIG. 2C shows an example of the data structure of the input data table;

FIG. 2D shows an example of the data structure of the display period table;

FIG. 2E shows an example of the data structure of the display information table;

FIG. 3A shows an example of the display of the schedule chart before automatically scaling the display period by selecting an item;

FIG. 3B shows an example of the display of the schedule chart after automatically scaling the display period by selecting a single item;

FIG. 3C shows an example of the display of the schedule chart after automatically scaling the display period by selecting a plurality of items;

FIG. 3D shows another example of the display of the schedule chart after automatically scaling the display period by selecting a single item;

FIG. 3E shows another example of the display of the schedule chart after automatically scaling the display period by selecting a plurality of items;

FIG. 4A is a flowchart showing the process of automatically scaling the display period by selecting an item;

FIG. 4B is another flowchart showing the process of automatically scaling the display period by selecting an item;

FIG. 4C is a flowchart showing the process of setting a flag;

FIG. 4D is a flowchart showing the process of converting coordinates according to the first embodiment of the present invention;

FIG. 4E is a flowchart showing the display of items;

FIG. 5A shows an example of the display of a schedule chart before automatically scaling a display period by selecting the display period;

FIG. 5B shows an example of the display of a schedule chart after automatically scaling a display period by selecting the display period;

FIG. 5C shows another example of the display of a schedule chart after automatically scaling a display period by selecting the display period;

FIG. 6A is a flowchart showing the process of automatically scaling the display period by selecting a display period;

FIG. 6B is another flowchart showing the process of automatically scaling the display period by selecting a display period;

FIG. 6C shows an example of the display of a schedule chart before and after automatically scaling a display period by selecting the display period;

FIG. 6D shows a practical example of a display period table;

FIG. 6E shows a practical example of a schedule chart;

FIG. 6F shows another practical example of a display period table;

FIG. 7A shows an example of the display before processing the schedule chart to be displayed with a specified object positioned in the center;

FIG. 7B shows an example of the display after processing the schedule chart to be displayed with a specified item positioned in the center;

FIG. 7C shows an example of the display after processing the schedule chart to be displayed with a specified date positioned in the center;

FIG. 7D is a flowchart showing the automatic adjustment process with a specified date displayed in the center;

FIG. 8A shows an example of the display after processing the schedule chart with a specified item displayed at an optional or predetermined position;

FIG. 8B shows an example of the display after processing the schedule chart with a specified date displayed at an optional or predetermined position;

FIG. 8C shows an example of the display after processing the schedule chart with the current date displayed at an optional or predetermined position;

FIG. 8D is a flowchart showing the automatic adjustment process for displaying a specified object at an optional or predetermined position;

FIG. 8E is a flowchart showing the conversion of coordinates according to the fourth embodiment of the present invention;

FIG. 9A shows an example of the display of a schedule chart before scaling up a target for display;

FIG. 9B shows an example of the display of a schedule chart after scaling up a target for display by selecting an item;

FIG. 9C shows an example of the display of a schedule chart after scaling up a target for display by selecting a display period;

FIG. 9D shows another example of the display of a schedule chart after scaling up a target for display by selecting an item;

FIG. 9E shows a further example of the display of a schedule chart after scaling up a target for display by selecting an item;

FIG. 9F shows a further example of the display of a schedule chart after scaling up a target for display by selecting an item;

FIG. 9G shows another example of the display of a schedule chart after scaling up a target for display by selecting a display period;

FIG. 9H shows a further example of the display of a schedule chart after scaling up a target for display by selecting a display period;

FIG. 9I shows a further example of the display of a schedule chart after scaling up a target for display by selecting a display period;

FIG. 9J shows an example of the display of a schedule chart before scaling up a target for display;

FIG. 9K shows another example of the display of a schedule chart after scaling up a target for display by selecting an item;

FIG. 9L shows another example of the display of a schedule chart after scaling up a target for display by selecting a display period;

FIG. 10A is a flowchart showing the automatic adjustment process for scaling up a target to be specified for display;

FIG. 10B is another flowchart showing the automatic adjustment process for scaling up a target to be specified for display;

FIG. 10C is a flowchart showing the process of converting coordinates according to the fifth embodiment of the present invention;

FIG. 10D shows a practical example showing the structure of the data in a weighting table;

FIG. 11A shows an example of the display of a schedule chart before scaling up or down a specified position;

FIG. 11B shows an example of the display of a schedule chart after scaling up a specified position;

FIG. 11C shows an example of the display of a schedule chart after scaling down a specified position;

FIG. 11D shows another example of the display of a schedule chart after scaling up a specified position;

FIG. 11E shows another example of the display of a schedule chart after scaling down a specified position;

FIG. 12A is a flowchart showing the process of scaling up or down a specified position;

FIG. 12B is another flowchart showing the process of scaling up or down a specified position;

FIG. 12C is a flowchart showing the process of converting coordinates according to the sixth embodiment of the present invention; and

FIG. 13 shows the system which realizes the functions of each of the embodiment of the present invention.

### DETAILED DESCRIPTION OF THE PREFERRED EMBODIMENT

The present invention is described in detail by referring to the attached drawings.

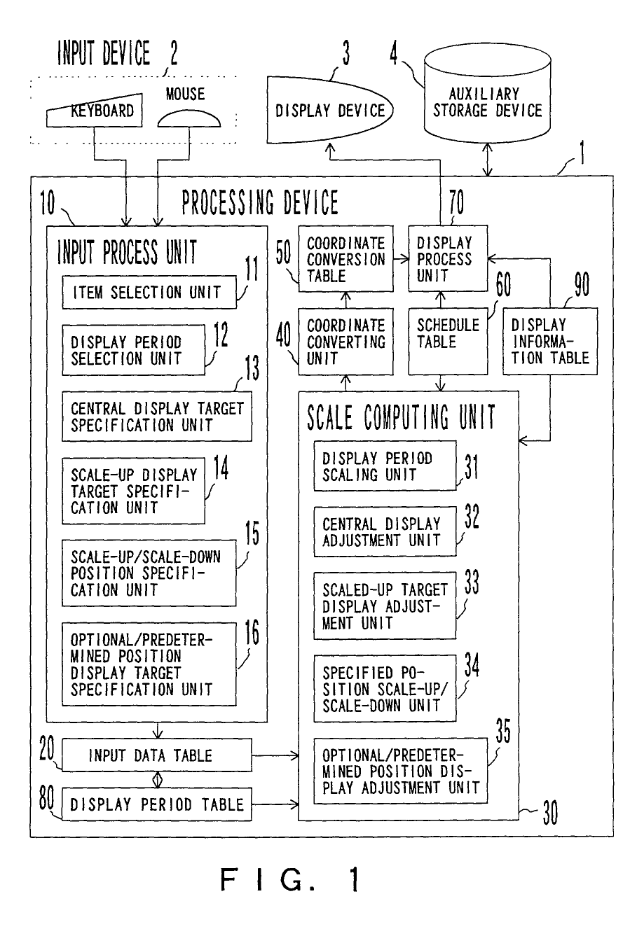

FIG. 1 shows an example of the configuration of the block according to the present invention.

The schedule management apparatus according to the present invention comprises a processing device 1 for performing a process described later through the CPU, memory, etc.; an input device 2 for inputting data and instructions such as a keyboard, a mouse, etc.; a display device 3 for displaying a schedule chart; and an auxiliary storage device 4 for storing information about schedule management. The processing device 1 comprises an input process unit 10, an input data table 20, a scale computing unit 30, a coordinate converting unit 40, a coordinate conversion table 50, a schedule table 60, a display process unit 70, a display period table 80, and a display information table 90.

The input process unit 10 processes the data, instructions, etc. input from the input device 2, writes the process result to the input data table 20, and comprises an item selection unit 11, a display period selection unit 12, a central display target specification unit 13, a scale-up display target specification unit 14, a scale-up/scale-down position specification unit 15, and an optional/predetermined position display target specification unit 16. The input data table 20 stores information such as an item, a date, etc. input from the input process unit 10. The input data table 20 is stored in the memory, etc.

The item selection unit 11 selects one or more target items according to the instruction input from the input device 2. The display period selection unit 12 selects the start and the end of a display period. The central display target specification unit 13 specifies a target date or item to be displayed in the center of the display period. The scale-up display target specification unit 14 specifies a target date, period or item when the target date, period, or item should be displayed in more detail than others. The scale-up/scale-down position specification unit 15 specifies the position to be scaled up or down in the displayed schedule chart. The optional/predetermined position display target specification unit 16 specifies a date or item to be displayed at an optional or predetermined position in the display period.

The scale computing unit 30 computes the scale of the period in a schedule chart by referring to the information stored in the input data table 20, or adjusts the range for display, transfers the result to the coordinate converting unit 40, and comprises a display period scaling unit 31, a central display adjustment unit 32, a scaled-up target display adjustment unit 33, a specified position scale-up/scale-down unit 34, and an optional/predetermined position display adjustment unit 35.

The display period scaling unit 31 automatically scales the display period based on the screen size such that the items stored in the input data table 20 can be completely displayed on the screen, or such that the display period depending on the date information stored in the input data table 20 can be completely displayed on the screen.

The central display adjustment unit 32 adjusts the start and the end of the period to be displayed such that the date or item stored in the input data table 20 can be displayed in the center of the display period.

The scaled-up target display adjustment unit 33 adjusts the display intervals of the unit of period in the display period such that the period containing the date or item stored in the input data table 20 can be larger than other periods.

The specified position scale-up/scale-down unit 34 scales up or down a display period with reference to the position specified on the screen and stored in the input data table 20.

The optional/predetermined position display adjustment unit 35 adjusts the start and end of the period to be displayed such that the date or item stored in the input data table 20 can be located at an optional or predetermined position in the display period.

The coordinate converting unit 40 converts the display coordinates such as items, etc. on the schedule chart based on the size of the display screen of the display device 3 according to the process result of the scale computing unit 30, and writes the converted coordinate data for re-display to the coordinate conversion table 50.

The coordinate conversion table 50 stores the coordinates converted by the coordinate converting unit 40 when the schedule chart is re-displayed on the display device 3. The schedule table 60 stores the information about the item to be displayed in the schedule chart. The coordinate conversion table 50 and the schedule table 60 are stored in the memory, etc.

The display process unit 70 displays a schedule chart on the display device 3 according to the information stored in the coordinate conversion table 50 and the schedule table 60.

The display period table 80 stores a specified display period.

The display information table 90 stores the information about the current display screen.

A program for realizing each of the above described processes performed by the processing device 1 using a computer can be stored on an appropriate storage medium such as portable computer-readable medium memory, semiconductor memory, a hard disk, etc.

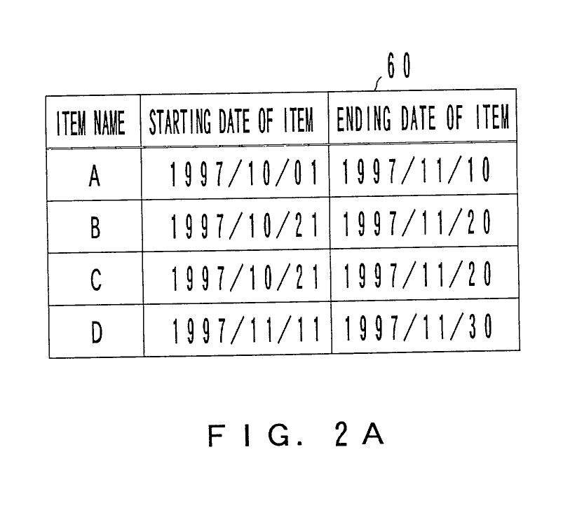

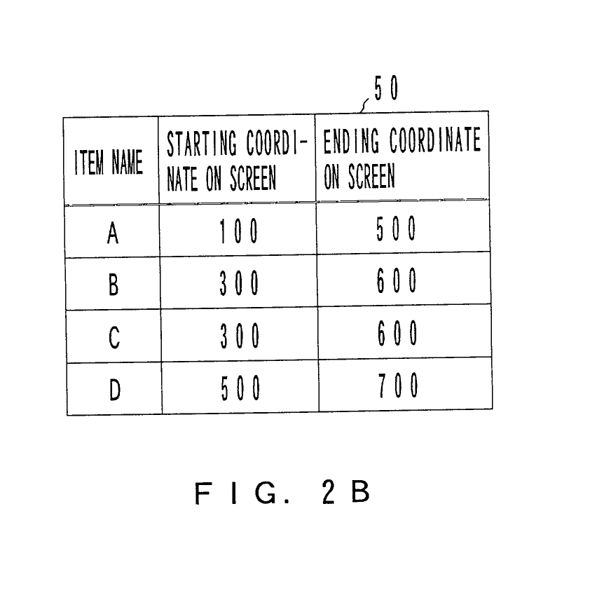

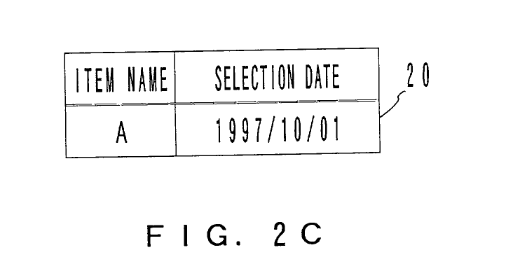

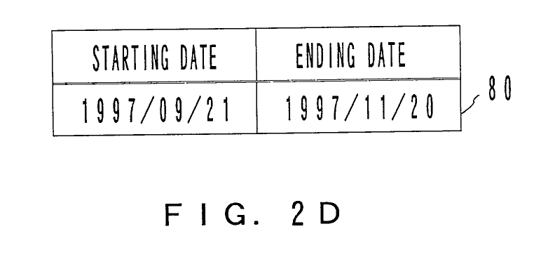

FIG. 2A shows the structure of the data in the schedule table 60. Shown in FIG. 2A, the name, the starting date, and the ending date of an item generated in the schedule chart are stored in the schedule table 60. In this example, data is referred to based on a calendar day, and the start/end of an item can contain time information.

FIG. 2B shows an example of the structure of the data in the coordinate conversion table 50. Shown in FIG. 2B, the name of an item, the starting and ending coordinates of the item on the screen when a picture is re-drawn are stored in the coordinate conversion table 50. These data are required when the schedule chart is displayed.

FIG. 2C shows an example of the structure of the data in the input data table 20. Shown in FIG. 2C, the information such as an operation (item), date, etc. input from the input device 2 such as a mouse, keyboard, etc. is stored in the input data table 20. Practically, the name of a selected or specified item, or the selected or specified date, or the selected date, and the selection date which is date information about the display period, etc. are stored. When an item is selected or specified by the input process unit 10, the selection date information is not stored, thereby making the selection date column empty. On the other hand, when the input process unit 10 selects or specifies a selection date (date information), the name of an item is not stored, thereby making the item name column empty.

FIG. 2D shows an example of the structure of the data in the display period table 80. Shown in FIG. 2D, the starting date and the ending date of the specified display period is stored in the display period table 80, and is linked to the input data table 20.

FIG. 2E shows an example of the structure of the data in the display information table 90. Shown in FIG. 2E, the starting date and the ending date of a display period on the current display screen, and the number of lines in which an item can be displayed are stored in the display information table 90.

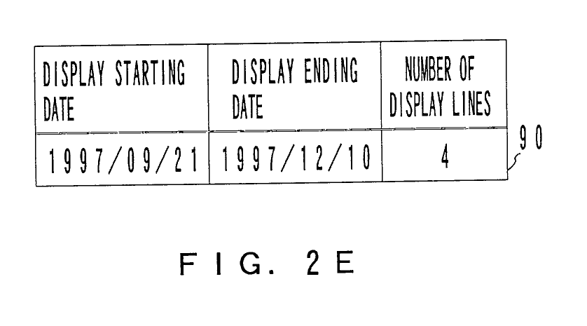

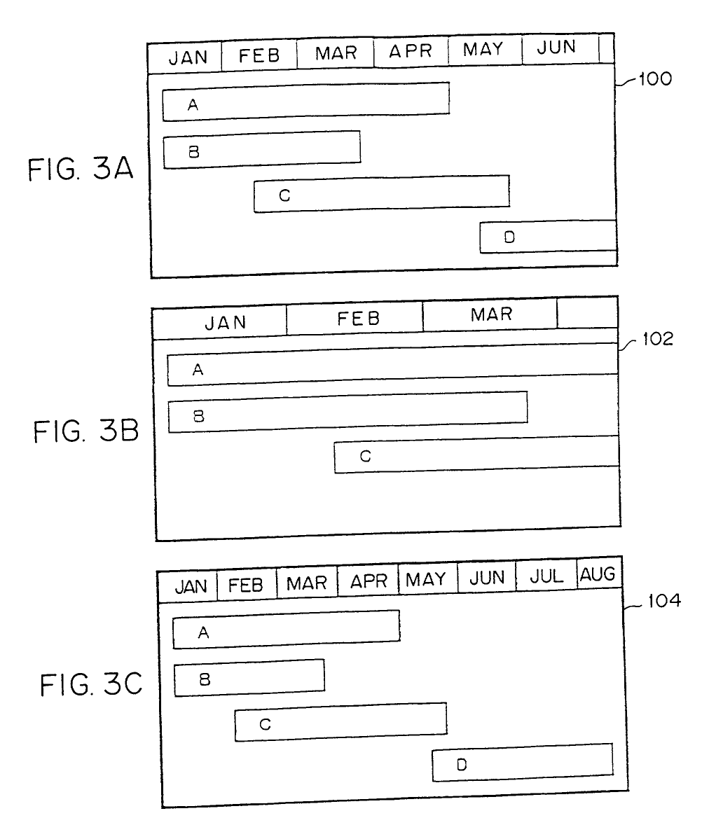

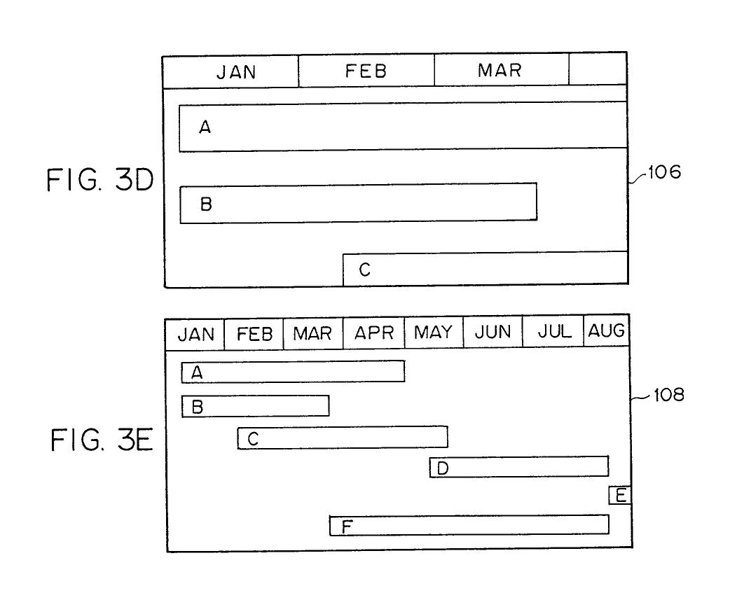

FIGS. 3A, 3B, 3C, 3D, and 3E show examples of automatically scaling a display period for display by selecting an item according to the first embodiment of the present invention.

FIG. 3A shows an example of the display of the schedule chart 100 before automatically scaling the display period by selecting an item.

January through June are displayed as display periods, and items A, B, C, and D are displayed as items in the schedule table 100.

FIG. 3B shows an example of the display of the schedule chart 102 after automatically scaling the display period by selecting a single item in the schedule chart 100 shown in FIG. 3A.

When a display period is automatically scaled by selecting, for example, an item B, with the schedule chart 100 as shown in FIG. 3A displayed on the display device 3, the menu or button (omitted in FIG. 3A) which indicates fitting a target item/period to the screen is selected on the screen to enter an automatic scale mode. Then, the item B is clicked by the input device 2 on the screen or selected from the item list displayed by the input device 2 on another screen.

The item selection unit 11 writes the item B to the item name column in the input data table 20 by selecting and inputting the item through the input device 2.

The display period scaling unit 31 detects the item name stored in the input data table 20, obtains the starting date and the ending date of the item B from the schedule table 60, and computes the scale of the period from the current display period and the period of the selected item B. Then, it transfers the computation result to the coordinate converting unit 40.

The coordinate converting unit 40 converts the coordinates for display of an item based on the size of the display screen of the display device 3, and writes the starting and ending coordinates for drawings on the screen to the coordinate conversion table 50. Based on the result, the display process unit 70 re-displays the schedule chart according to the new scale of period.

Thus, as shown in FIG. 3B, the display device 3 re-displays the schedule chart 102 for which a display period is scaled up based on the screen size such that the item B can be completely displayed on the screen.

FIG. 3C shows an example of the display of the schedule chart 104 when a plurality of items are selected by the item selection unit 11.

For example, when the input device 2 selects four items A through D in the automatic scale mode, the item selection unit 11 writes the items A through D in the item name column in the input data table 20.

The display period scaling unit 31 detects the item names (items A through D) stored in the input data table 20, computes the scale of a period based on the screen size such that all these items can be completely displayed on the screen, and transfers the computation result to the coordinate converting unit 40.

In the similar processes, the display period is scaled down such that the period can be completely displayed for all items A through D, the schedule chart is re-displayed on the display device 3 as shown in FIG. 3C.

FIG. 3D shows another example of the display of the schedule chart 106 after automatically scaling the display period by selecting a single item in the schedule chart 100 as shown in FIG. 3A.

As in the example shown in FIG. 3B, the item selection unit 11 writes the item B in the item name column in the input data table 20 when the item B is selected through the input device.

The display period scaling unit 31 detects the item name stored in the input data table 20, obtains the starting date and the ending date of the item B from the schedule table 60, and computes the scale of the period from the current display period and the period of the selected item B. Then, it transfers the computation result to the coordinate converting unit 40.

The coordinate converting unit 40 converts the coordinates for display of an item based on the size of the display screen of the display device 3, and writes the starting and ending coordinates in the vertical direction (Y direction) and the horizontal direction (X direction) for drawings on the screen to the coordinate conversion table 50. Based on the result, the display process unit 70 re-displays the schedule chart according to the new scale of period.

Thus, as shown in FIG. 3D, the display period is scalded up based on the screen size such that the item B can be completely displayed on the screen. Furthermore, each item is scaled up in the vertical and horizontal directions for re-display corresponding to the scale-up of the display period.

In this case, the coordinates of the selected item B before the scaling process are converted for scaling up based on the size of the display screen, but the item can also be scaled down. For example, if the display period of the item B is too long to be displayed within the size of the display screen before the scaling process, then the item B should be scaled down by the coordinate conversion so that it can be displayed in the display screen. It holds true with the above described example shown in FIG. 3B.

FIG. 3E shows another example of the display of the schedule chart 108 after automatically scaling the display period by selecting a plurality of items of the schedule chart 100 shown in FIG. 3A.

If the four items A through D are selected from the input device 2 as in the example shown in FIG. 3C, then the item selection unit 11 writes the items A through D in the item name columns in the input data table 20.

The display period scaling unit 31 detects the item names (items A through D) stored in the input data table 20, computes the scale of the period based on the screen size such that all these items can be completely displayed on the screen, and transfers the computation result to the coordinate converting unit 40.

The coordinate converting unit 40 converts the display coordinates of each item based on the size of the display screen of the display device 3, and writes to the coordinate conversion table 50 the starting coordinates in the vertical direction (Y direction) and the horizontal direction (X direction) and the ending coordinates in the vertical direction (Y direction) and the horizontal direction (X direction) on the screen for re-drawing a picture on the screen. The display process unit 70 re-displays the schedule chart 108 on the display device 3 according to the new scale of period based on the above described result.

Thus, the display period is scaled down according to the screen size such that all the items A through D can be completely displayed on the screen as shown in FIG. 3E, and each item is scaled down for redisplay in the vertical and horizontal directions corresponding to the scale down of the display period.

In this case, the coordinates of the selected items A through D before the scaling process are converted for scaling down based on the size of the display screen, but the item can also be scaled up. For example, if the display period of the items A through D is so short in the size of the display screen before the scaling process, then the display period should be scaled up by the coordinate conversion so that it can be displayed large on the display screen. It holds true with the above described example shown in FIG. 3C.

Thus, by making the best of the screen size, a target item can be scaled up for display, or all target items can be displayed on the same screen. In these examples, the target one or more items are selected after selecting the automatic scale mode for the display period. However, an instruction to automatically scale the display period can be input after selecting one or more items first.

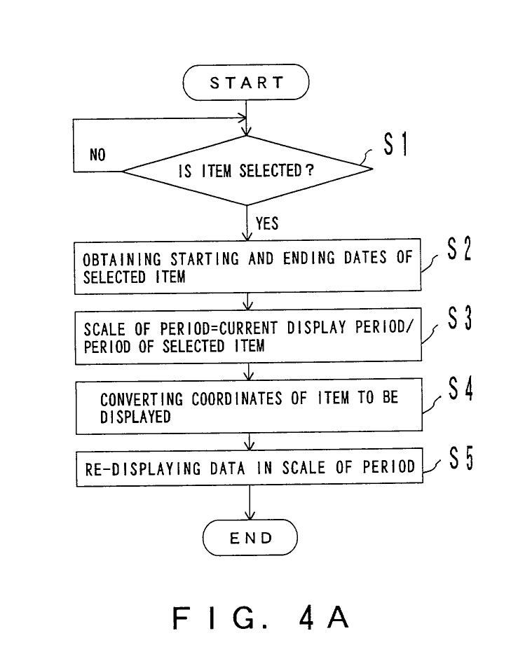

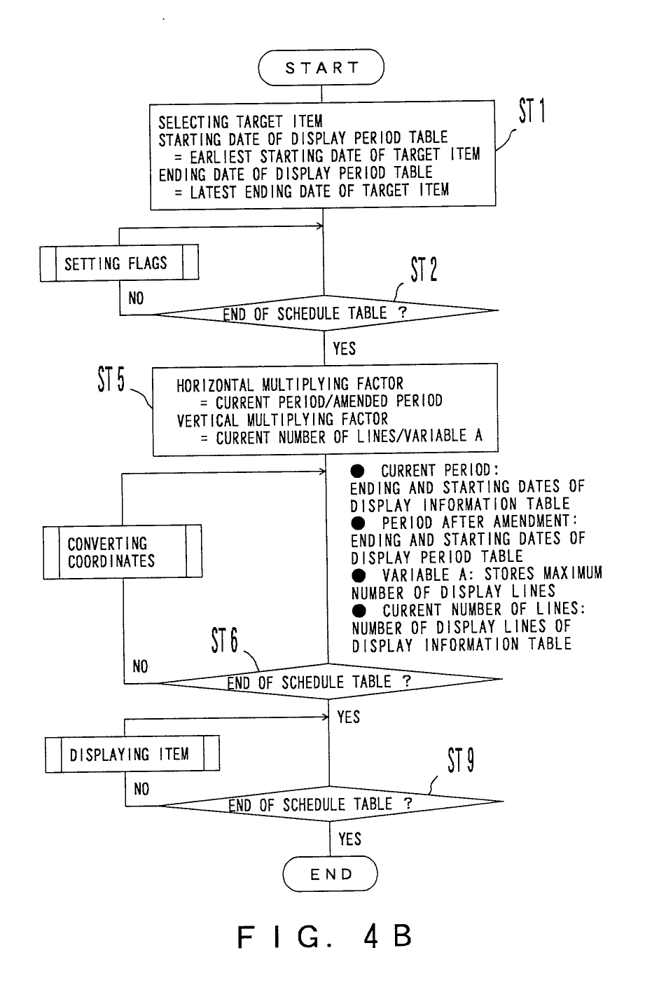

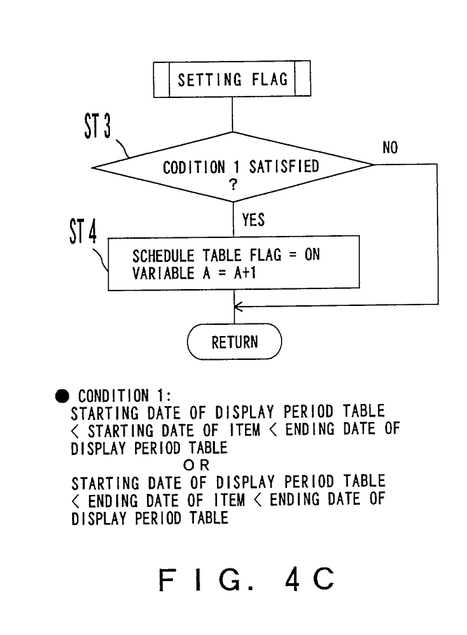

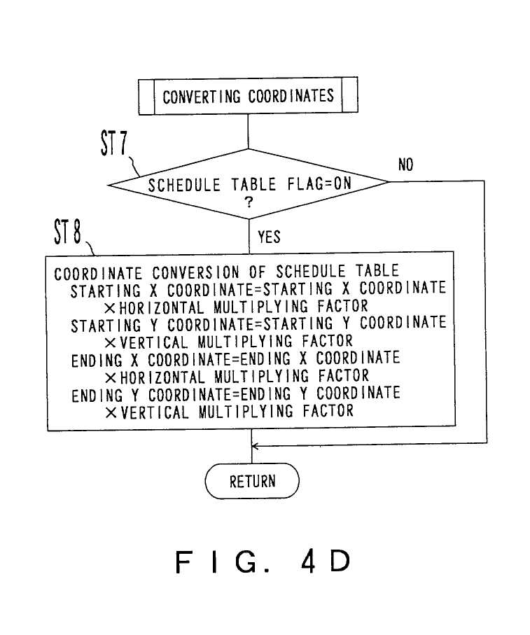

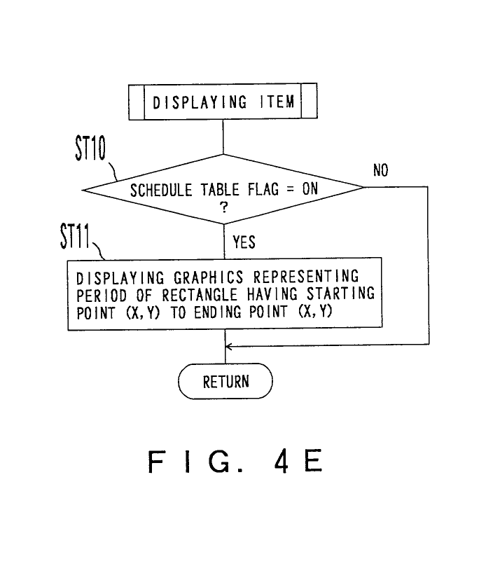

FIG. 4A is a flowchart showing the process of automatically scaling the display period by selecting an item according to the first embodiment of the present invention.

The display period scaling unit 31 waits till an item is selected by the item selection unit 11 (S1), and obtains from the schedule table 60 the starting date and the ending date stored in the input data table 20 when the item is selected (S2). When a plurality of items are selected, the period from the earliest date to the latest date of the selected items is the period of the selected item.

Next, the scale of the period is computed by the following equation.

Scale of period=current display period/period of selected item

Then, the computation result is transferred to the coordinate converting unit 40 (S3).

The coordinate converting unit 40 converts the coordinates of an item to be displayed and writes them to the coordinate conversion table 50 (S4). The display process unit 70 re-displays the schedule chart based on the scale of the period computed by the display period scaling unit 31 according to the information of the coordinate conversion table 50 (S5).

FIGS. 4B, 4C, and 4D are flowcharts showing the process of automatically scaling the display period by selecting an item according to the first embodiment of the present invention. Particularly, they show the process of an example in which the item is scaled up or down in the vertical and horizontal directions.

In step ST1 shown in FIG. 4B, the item selection unit 11 selects an item, and the earliest starting date in the starting dates of selected items is the starting date of the display period table 80 whereas the latest ending date in the ending dates of selected items is the ending date of the display period table 80.

In step ST2, the process is performed until the last item in the schedule table 60 is processed in the loop of the re-displayed item recognition flag setting routine.

FIG. 4C shows the settings of a flag.

In step ST3, it is determined whether or not the starting or ending date of the item comes between the starting date and the ending date of the schedule table 60 (condition 1).

If the condition 1 is satisfied, the flag of the item in the schedule table 60 is set ON from its initial value OFF, and the variable A is incremented by 1 from its initial value 0 in step ST4.

In step ST5 back in FIG. 4B, the horizontal and vertical multiplying factors are determined. The horizontal multiplying factor is obtained by dividing the value obtained by subtracting the starting date from the ending date of the display information table 90 by the value obtained by subtracting the starting date from the ending date of the display period table 80. The vertical multiplying factor is obtained by dividing the number of displayed lines of the display information table 90 by the variable A.

In step ST6, the process is performed until the last item in the schedule table 60 is processed in the loop of the re-displayed item coordinate conversion routine.

FIG. 4D shows the conversion of coordinates.

In step ST7, it is determined whether or not the flag of the item in the schedule table 60 is set ON.

If the flag is set ON, the starting X coordinate is multiplied by the horizontal multiplying factor to obtain a new starting X coordinate. The starting Y coordinate is multiplied by the vertical multiplying factor to obtain a new starting Y coordinate. The ending X coordinate is multiplied by the horizontal multiplying factor to obtain a new ending X coordinate. The ending Y coordinate is multiplied by the vertical multiplying factor to obtain a new ending Y coordinate.

In step ST9 back in FIG. 4B, the process is performed until the last item in the schedule table 60 is processed in the loop of the item re-display routine.

FIG. 4E shows the conversion of coordinates.

In step ST10, it is determined whether or not the flag of the item in the schedule table 60 is set ON.

If the flag is set ON, items are displayed according to the starting X and Y coordinates, and the ending X and Y coordinates after the conversion in step ST11.

Therefore, according to the first embodiment of the present invention, a target item can be displayed based on the size of the display screen only by selecting the target item. As a result, the user of the schedule chart can display the target item without repeatedly scrolling the screen or scaling up or down the screen.

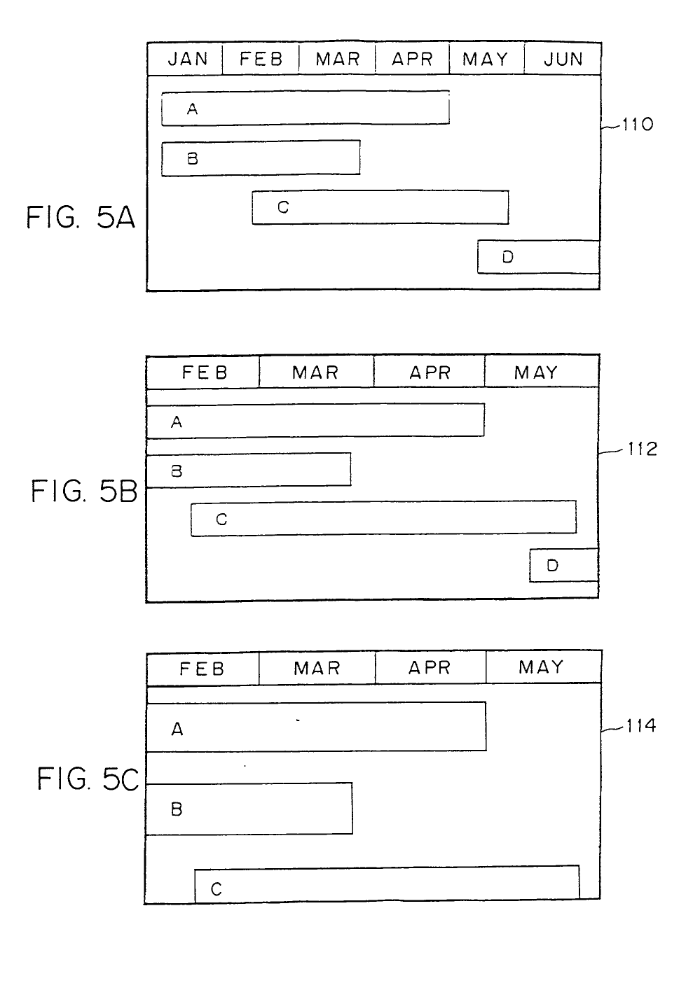

FIGS. 5A, 5B, and 5C show examples of automatically scaling a display period for display by selecting the display period according to the second embodiment of the present invention.

FIG. 5A shows an example of the display of a schedule chart 110 before automatically scaling a display period by selecting the display period.

In the schedule chart 110, January through June are displayed as a display period, and four items A through D are displayed.

FIG. 5B shows an example of the display of a schedule chart 112 after automatically scaling a display period by selecting the display period.

Assume that the display period, for example, from February to May, is selected and the display period is automatically scaled with the schedule chart 110 as shown in FIG. 5A displayed on the display device 3. First, a display period automatic scale menu or button (not shown in FIG. 5) through which a target item/period can be fitted to the screen is selected on the screen to enter the automatic scale mode. Then, February and May are selected as the display period by the input device 2.

A display period can be selected through the display period selection unit 12 by inputting the starting position and the ending position clicked on the display of a period scale on the screen, or by inputting a starting month (or day) and an ending month (or day) in a dialog box (not shown in FIG. 5) to which a display period is input.

The input device 2 inputs a selected display period to the display period selection unit 12, and the display period selection unit 12 writes February and May as the date information into the column of a selection date in the input data table 20.

The display period scaling unit 31 detects the selection date in the input data table 20, automatically computes the scale of the period based on the screen size such that the data from February to May can be displayed on the screen, and transfers the computation result to the coordinate converting unit 40.

The coordinate converting unit 40 converts the display coordinates of each item based on the scale of the period computed by the display period scaling unit 31, and writes to the coordinate conversion table 50 the starting and ending coordinates on the screen for re-display. The display process unit 70 redisplays the schedule chart based on the result on the display device 3 according to the new scale period.

As shown in FIG. 5B, the display period is scaled up such that the period from February to May can be fitted to the screen size, and the schedule chart 112 is re-displayed on the display device 3. Therefore, a target display period can be appropriately displayed by making the best of the screen size.

FIG. 5C shows another example of the display of a schedule chart 114 after automatically scaling a display period by selecting the display period in the schedule chart 110 as shown in FIG. 5A.

As in the example shown in FIG. 5B, when February and May are selected through the input device 2, the display period selection unit 12 writes the date information, that is, February and may, into the selection date column in the input data table 20.

The display period scaling unit 31 detects the selection date in the input data table 20, automatically computes the scale of the period based on the screen size such that the data from February to May can be displayed on the screen, and transfers the computation result to the coordinate converting unit 40.

The coordinate converting unit 40 converts the display coordinates of each item based on the scale of the period computed by the display period scaling unit 31, and writes to the coordinate conversion table 50 the starting coordinates in the vertical direction (Y direction) and the horizontal direction (X direction) and ending coordinates in the X and Y directions on the screen for re-display. The display process unit 70 re-displays the schedule chart based on the result on the display device 3 according to the new scale period.

As shown in FIG. 5C, the display period is scaled up such that the period from February to May can be fitted to the screen size, each item is scaled up in the vertical and horizontal directions corresponding to the scale-up of the display period, and the schedule chart is re-displayed on the display device 3.

In this case, the selected period covers February to May, and is shorter than the originally displayed period from January to June. Therefore, the redisplayed period has been scaled up. If the selected period covers January to July, the re-displayed period has been scaled down. This is similar to the example shown in FIG. 5B.

In these examples, the automatic display period scale mode is first selected, and then the start and the end of the display period are specified. An instruction to automatically scale up or down a display period can also be issued after inputting the start and the end of a display period.

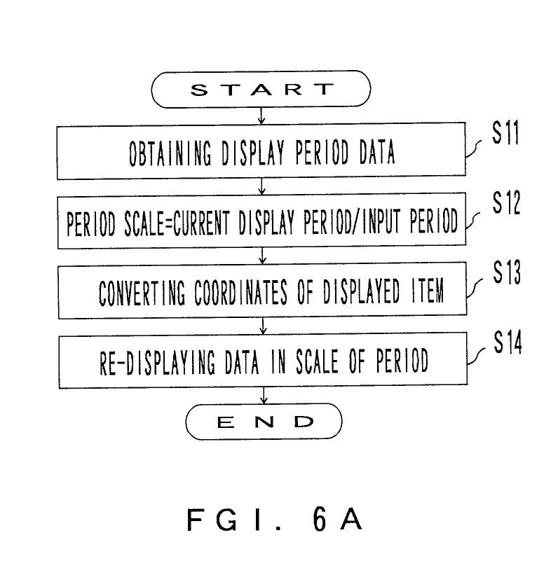

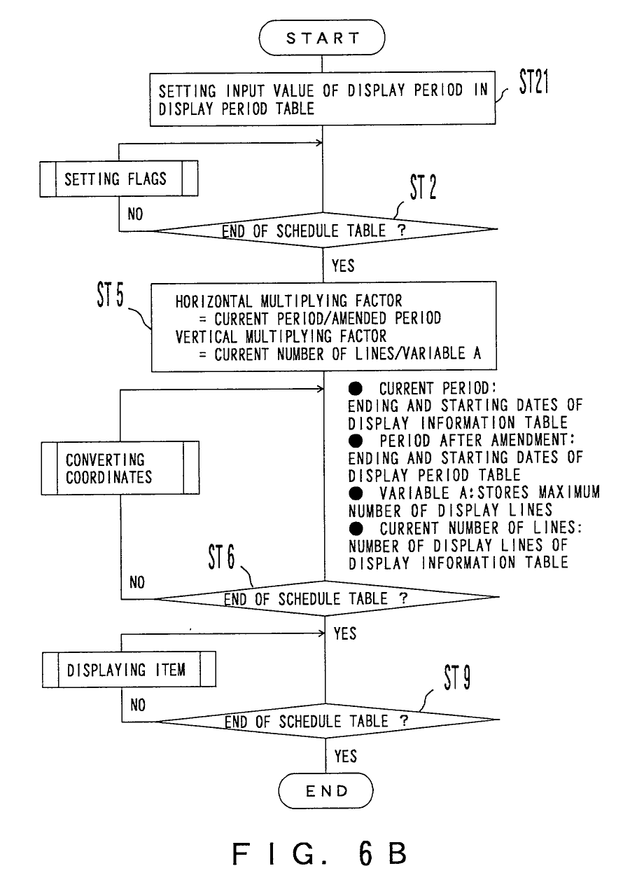

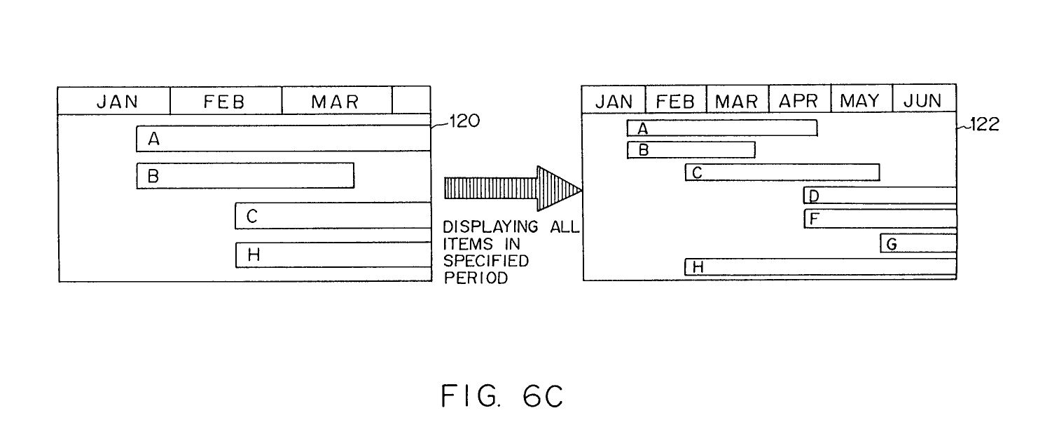

FIG. 6A is a flowchart showing the process of automatically scaling a display period by selecting the display period.

The display period scaling unit 31 searches the input data table 20, obtains the display period data, that is, the starting month and the ending month of the display period from the schedule table 60 (S11). Then, the display period scaling unit 31 computes the scale of the period by the following equation.

Scale of period=current display period/period of selected item

Then, the computation result is transferred to the coordinate converting unit 40 (S12).

The coordinate converting unit 40 converts the coordinates of an item to be displayed and writes them to the coordinate conversion table 50 (S13). The display process unit 70 re-displays the schedule chart based on the scale of the period computed by the display period scaling unit 31 according to the information of the coordinate conversion table 50 (S14).

FIG. 6B is a flowchart showing the process of automatically scaling the display period by selecting a display period according to the second embodiment of the present invention, and particularly showing an example in which an item is scaled up or down in the vertical and horizontal directions.

In step ST21, the display period selection unit 12 selects a display period. The starting date of the selected display period is the starting date of the display period table 80, and the ending date of the selected display period is the ending date of the display period table 80.

Then, the processes in steps ST2 through ST9 including the flag setting routine, the coordinate conversion routine, and the item display routine are the same as those according to the first embodiment of the present invention. Consequently, the descriptions about these processes are omitted here.

The second embodiment of the present invention is described below by referring to a practical example.

FIG. 6C shows an example of the change of a schedule chart by automatically scaling a display period after selecting the display period. In FIG. 6C, the schedule chart 120 on the left is obtained before the scaling process, and indicates the data from Jan. 1 to Apr. 10. Items A, B, C, and H within the period are displayed. In FIG. 6C, the schedule chart 122 on the right is obtained after the scaling process, and indicates the data from Jan. 1 to Jun. 30. Items A, B, C, D, F, G, and H within the period are displayed.

First, the operator indicates the display period to the schedule management device through the input device 2 to enter an automatic display period scale mode. Then, ‘Jan. 1, 199x’ is input through the input device 2 to display the schedule from Jan. 1, 199x to Jun. 20, 199x. Then, the display period selection unit 12 writes the data ‘Jan. 1, 199x’ to the selection date column in the input data table 20, and to the starting date column in the display period table 80A as shown in FIG. 6D. Similarly, ‘Jun. 20, 199x’ is input through the input device 2. Then, the display period selection unit 12 writes the data ‘Jun. 20, 199x’ to the selection date column in the input data table 20, and to the ending date column in the display period table 80A as shown in FIG. 6D.

Then, the display period scaling unit 31 repeats the flag setting routine on all lines in the schedule table 60A shown in FIG. 6E. That is, the display period scaling unit 31 determines whether or not the condition that the starting date or the ending date of each item comes between the starting date and the ending date in the display period table 80A. Since the starting date ‘Jan. 21, 199x’ and the ending date ‘Apr. 20, 199x’ of an item A come between the starting date ‘Jan. 1, 199x’ and the ending date ‘Jun. 20, 199x’ of the display period table 80A, the condition is satisfied. When the condition is satisfied, the flag column whose initial value is OFF is set ON. The item A is set ON. When the flag is set ON, the variable A whose initial value is 0 is incremented by 1. Similarly, the flags are set ON for items B and C, and the variable A is incremented. At this time, the variable A is 3. As for the next item D, the starting date ‘Apr. 21, 199x’ of the item comes between the starting date ‘Jan. 1, 199x’ and the ending date ‘Jun. 20, 199x’ of the display period table 80A, and the above described condition is satisfied. Accordingly, the flag column is set to ON, and the variable is incremented by 1. As for the next item E, the starting date ‘Jul. 21, 199x’ and the ending date ‘Sep. 20, 199x’ of the item do not come between the starting date ‘Jan. 1, 199x’ and the ending date ‘Jun. 20, 199x’ of the display period table 80A. Therefor, the above described condition is not satisfied. Unless the condition is satisfied, the flag column remains ‘OFF’, and the variable A is not incremented by 1. The flag setting routine is repeated until an item J is processed. At this time, the flag of each item is ON for the items A, B, C, D, F, G, and H, and the flag is OFF for the items E, I, and J. The variable A is 7.

When the flag setting routine terminates, the display period scaling unit 31 obtains the horizontal multiplying factor and the vertical multiplying factor. The horizontal multiplying factor is obtained by dividing 99, which is obtained by subtracting the starting date ‘Jan. 1, 199x’ from the ending date ‘Apr. 10, 199x’ of the display information table 90A shown in FIG. 6F, by 170, which is obtained by subtracting the starting date ‘Jan. 1, 199x’ from the ending date ‘Jun. 20, 199x’ of the display period table 80A. That is, the horizontal multiplying factor is 0.58. The vertical multiplying factor is obtained by dividing 4, which is the number of display lines in the display information table 90A, by 7 which is the current variable A. That is, the vertical multiplying factor is approximately 0.57.

Next, the coordinate converting unit 40 repeats the coordinate conversion routine for all lines in the schedule table 60A shown in FIG. 6E. That is, it is determined whether the flag is ON or OFF for each item. The coordinate conversion is performed only on an item for which the flag is ON. The coordinate conversion for the X direction is performed by the multiplication by a horizontal multiplying factor, and the coordinate conversion for the Y direction is performed by the multiplication by a vertical multiplying factor. FIG. 6E shows the result of the coordinate conversion.

In the present invention, the coordinates refer to X and Y coordinates in the two-dimensional array having the left top point of the screen as an origin. In this example, the origin in the X direction refers to Jan. 1, 199x before and after the scaling process. However, when the operator indicates ‘Feb. 1, 199x to Jun.20, 199x’ as the display period, the origin refers to Feb. 1, 199x after the scaling process.

Next, the display process unit 70 refers to the schedule table 60A in FIG. 6E, repeats the item display routine, and re-displays the schedule chart 122. That is, it is determined whether the flag is ON or OFF for each item. An item is displayed only if the flag is ON for the item, and the schedule chart 122 is re-displayed as shown on the right in FIG. 6C.

Therefore, according to the first embodiment of the present invention, a target period can be displayed based on the size of the display screen only by selecting the target period. As a result, the user of the schedule chart 122 can display the target period without repeatedly scrolling the screen or scaling up or down the screen.

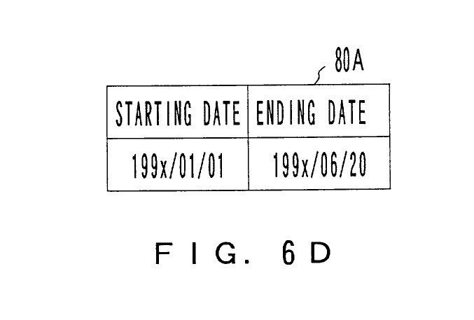

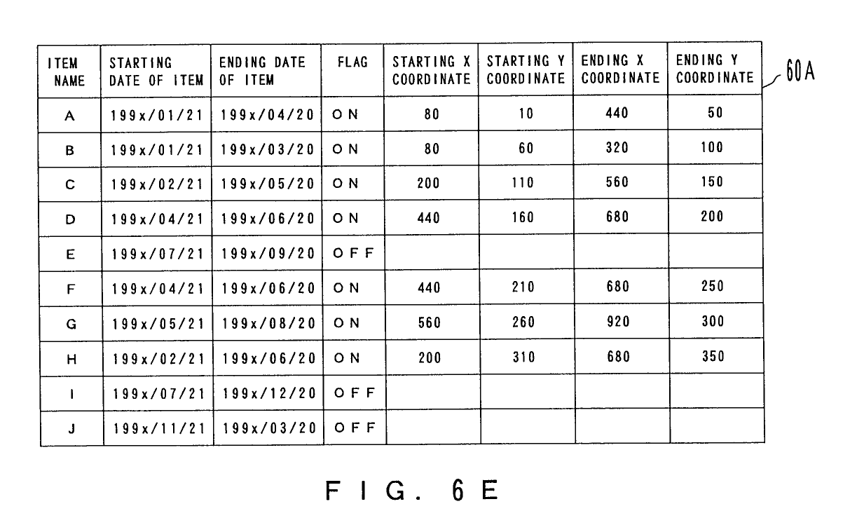

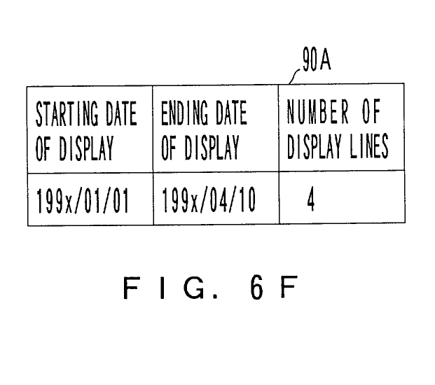

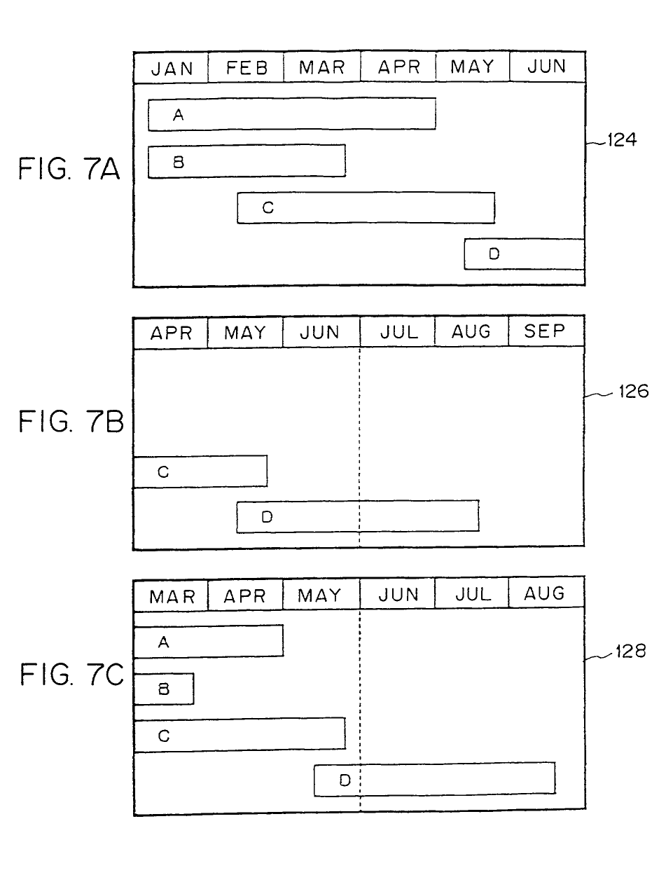

FIGS. 7A, 7B, and 7C show examples of the display through an automatic adjustment process to display a specified target object positioned in the center according to the third embodiment of the present invention.

FIG. 7A shows an example of the display before processing the schedule chart 124 in the automatic adjustment process to display a specified object positioned in the center.

January through June are displayed as a display period, and four items A, B, C, and D are displayed as target items.

FIG. 7B shows an example of the display after processing the schedule chart 126 in the automatic adjustment process to display a specified item positioned in the center by selecting an item in the schedule chart 124 shown in FIG. 7A. FIG. 7C shows an example of the display after processing the schedule chart 128 in the automatic adjustment process to display a specified item positioned in the center by selecting a specific date in the schedule chart 124 shown in FIG. 7A.

With the schedule chart 124 as shown in FIG. 7A displayed on the display device 3, it is assumed that the schedule information should be confirmed based on, for example, a specific item D or a specific date (Jun. 1).

In this case, a menu or a button (not shown in the attached drawings) indicating that a specified target should be displayed in the center is selected on the screen to enter a mode in which a specified target is displayed in the center. Then, a specified target such as the item D, ‘Jun. 1’, etc. is input through the input device 2. A specified target can be input using any method or device such as a mouse button, a dialog box, etc. It is desired that a specified date can also be input using a button indicating the current date, etc. as a specified data.

When the item D is selected and input through the input device 2, the central display target specification unit 13 writes ‘item D’ in the item name column in the input data table 20.

The central display adjustment unit 32 detects an item name stored in the input data table 20, adjusts the start and the end of the display period such that the item D is positioned in the center of the display period on the screen, and transfers the process result to the coordinate converting unit 40.

The coordinate converting unit 40 converts the display coordinates of each item in the schedule chart based on the size of the display screen of the display device 3, and writes to the coordinate conversion table 50 the starting and ending coordinates for redisplay on the screen. Thus, as shown in FIG. 7B, the display process unit 70 re-displays the schedule chart 126, whose display period is adjusted such that the item D can be displayed in the center, on the display device 3 according to the coordinate conversion table 50.

When ‘Jun. 1’, which is a specified date to be displayed in the center, or the current date (for example, ‘Jun. 1’) is input through the input device 2, the central display target specification unit 13 writes the date information of June 1 to the selection date column in the input data table 20.

Thus, the central display adjustment unit 32 adjusts the display period such that the specified date or the current date, that is, Jun. 6, can be displayed in the center. Then, the central display adjustment unit 32 transfers the result to the coordinate converting unit 40. Similarly, as shown in FIG. 7C, the schedule chart 128, whose display period is adjusted such that Jun. 1 can be displayed in the center, is re-displayed on the display device 3. As a result, the specified target date or item is displayed in the center of the screen so that the schedule before and after the central date or item can be easily accessed.

In this example, the mode in which a specified target is displayed in the center is first selected, and then the specified target date or item is specified. On the other hand, a specified target can be input first, and then an instruction to display the specified target in the center can be input.

FIG. 7D is a flowchart showing the automatic adjustment process with a specified date displayed in the center. The similar process is to be performed in the case in which a specified item is displayed in the center of the screen.

The central display adjustment unit 32 obtains from the input data table 20 a reference date to be displayed in the center of the screen (S21), adjusts the start and end of the display period such that the date can be displayed in the center of the screen, and passes the result to the coordinate converting unit 40 (S22).

The coordinate converting unit 40 converts the coordinates of the item to be displayed in the display period, and writes them to the coordinate conversion table 50 (S23). The display process unit 70 redisplays a schedule chart according to the information in the coordinate conversion table 50 (S24).

Consequently, according to the third embodiment of the present invention, an item or date can be displayed in the center of the screen only by selecting a specified item or date. Therefore, the user of the schedule chart can easily access a target item or date displayed in the center of the screen without scrolling the screen.

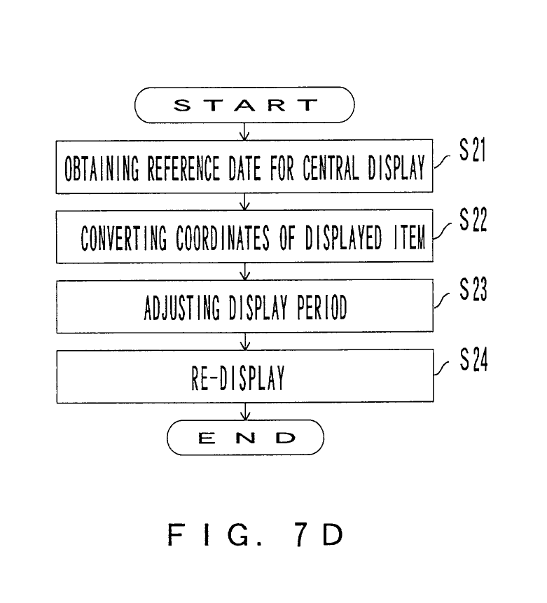

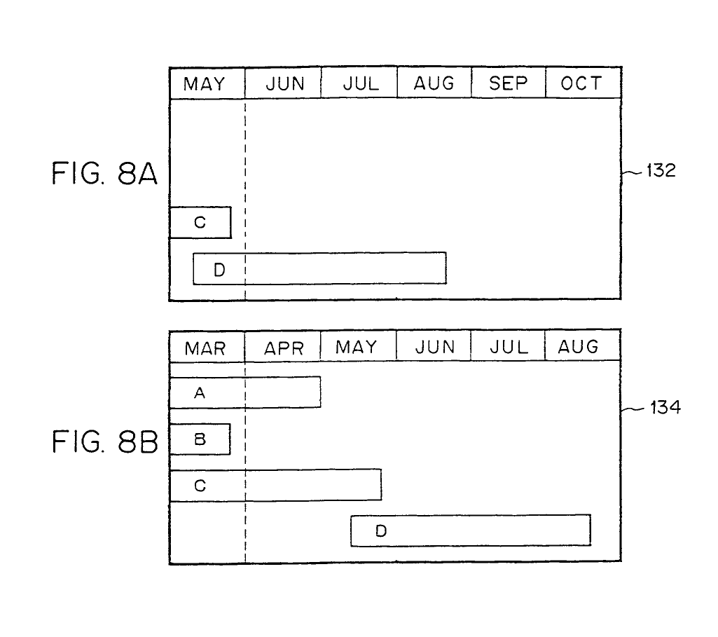

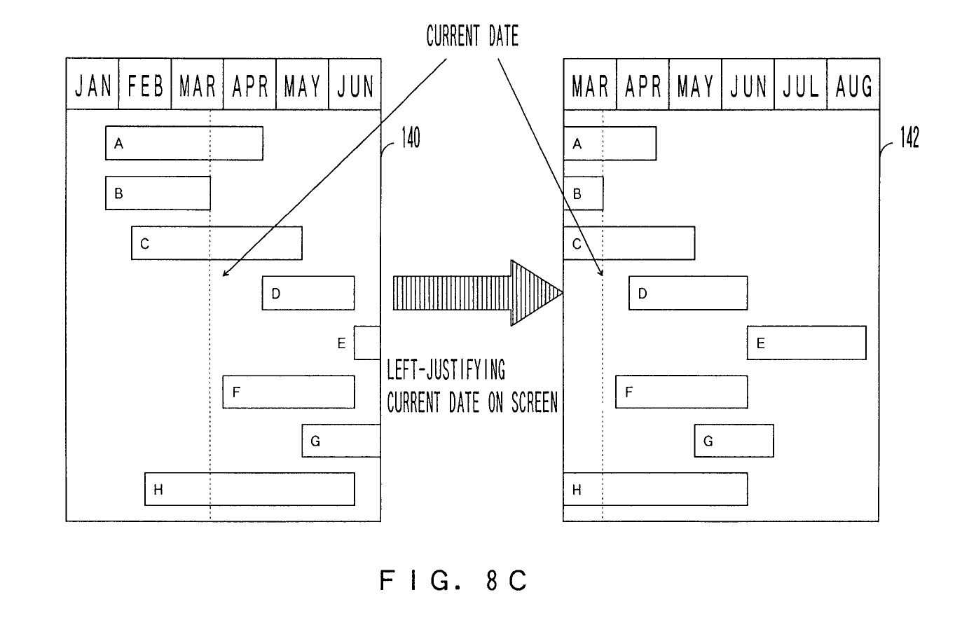

FIGS. 8A, 8B, and 8C show examples of the display in an automatic adjustment process to display a specified item at an optional or predetermined position according to the fourth embodiment of the present invention.

The fourth embodiment of the present invention is different from the third embodiment in that a specified target is automatically adjusted to be displayed at an optional or predetermined position according to the fourth embodiment while a specified target is automatically adjusted to be displayed in the center of the screen according to the third embodiment.

FIGS. 8A and 8B show examples of the display of a schedule chart after the automatic adjustment process to display a specified target at an optional or predetermined position by selecting an item from the schedule chart 124 as shown in FIG. 7A referred to in the descriptions according to the third embodiment of the present invention.

With the schedule chart 124 as shown in FIG. 7A displayed on the display device 3, it is assumed that the schedule information should be confirmed based on, for example, a specific item D or a specific date (Apr. 1).

In this case, a menu or a button (not shown in the attached drawings) indicating that a specified target should be displayed at an optional position or a predetermined position is selected on the screen using the input device 2 to enter a mode in which a specified target is displayed at an optional position or a predetermined position. Then, a specified target such as the item D or ‘Apr. 1’, etc. is input through the input device 2. A specified target can be input using any method or device such as a mouse button, a dialog box, etc.

In the mode in which a specified target is displayed at an optional position, a position at which a specified target is to be displayed is input. In the mode in which a specified target is displayed at a predetermined position, a position at which a specified target is to be displayed is selected in a menu or a button. For example, a position close to the leftmost position, or a position two months from the leftmost position is input or selected.

The optional/predetermined position display target specification unit 16 writes the ‘item D’ into the item name column in the input data table 20 when the item D to be displayed at a specified position or a predetermined position or a predetermined position is input through the input device 2.

The optional/predetermined position display adjustment unit 35 detects the item name stored in the input data table 20, adjusts the start and the end of the display period such that the item D can be displayed at a specified position or a predetermined position in the display period on the screen, and transfers the process result to the coordinate converting unit 40.

The coordinate converting unit 40 converts the display coordinates of each item in the schedule chart based on the size of the display screen of the display device 3, and writes to the coordinate conversion table 50 the starting and ending coordinates on the screen for re-display. Thus, as shown in FIG. 8A, the display process unit 70 re-displays on the display device 3 based on the coordinate conversion table 50 the schedule chart 132 in which the display period has been adjusted such that the item D can be displayed at a position close to the leftmost position.

Furthermore, the optional/predetermined position display target specification unit 16 writes the date information ‘Apr. 1’ into the selection date column in the input data table 20 when ‘Apr. 1’ is input as a specified day to be displayed at an optional position or a predetermined position specified by the input device 2.

The optional/predetermined position display adjustment unit 35 adjusts the display period such that the specified date ‘Apr. 1’ can be displayed at an optional position or a predetermined position, and transfers the result to the coordinate converting unit 40. In the similar process, as shown in FIG. 8B, a schedule chart 134 in which the display period has been adjusted such that April containing the date ‘Apr. 1’ can be displayed at a position of two months from the leftmost position is re-displayed on the display device 3. Thus, the schedule chart 134 of a target item or a specified date can be displayed at a desired position.

FIG. 8C shows an example of the change after processing the schedule chart in the automatic adjustment process to display the current date as a specified target at an optional or predetermined position.

The current date is March 20, and an optional or predetermined position is close to the leftmost position. In FIG. 8C, the schedule chart 140 on the left is to be processed. The schedule chart 142 on the right has been processed. Thus, the schedule after the current date is displayed.

FIGS. 8D and 8E are flowcharts showing the automatic adjustment process for displaying a specified object at an optional or predetermined position according to the fourth embodiment of the present invention. Particularly, FIGS. 8D and 8E are flowcharts showing the process in which an item is scaled up or down in the vertical and horizontal directions.

In step ST31 shown in FIG. 8D, an item or date is selected as a display target through the input device 2. The selected item is written to the item name column in the input data table 20, or the selected date is written to the selection date column in the input data table 20. Furthermore, the X coordinate of the selected item or date is set as a variable B, and the Y coordinate is set as a variable C.

In step ST32, the X and Y coordinates of an optional position or a predetermined position specified by the optional/predetermined position display target specification unit 16 are set as variables D and E respectively.

The processes in the subsequent steps ST2 through ST5 including the flag setting routine are the same as those according to the above described first embodiment of the present invention. Therefore, the detailed explanation about the processes are omitted here.

In step ST34, the process is performed until the last item in the schedule table 60 is processed in the loop of the redisplayed item coordinate conversion routine.

FIG. 8E shows the conversion of coordinates.

In step ST35, it is determined whether or not the flag of an item in the schedule table 60 is set ON.

If the flag is set ON, the starting X coordinate is obtained by multiplying the original starting X coordinate by a horizontal multiplying factor, the starting Y coordinate is obtained by multiplying the original starting Y coordinate by a vertical multiplying factor, the ending X coordinate is obtained by multiplying the original ending X coordinate by a horizontal multiplying factor, and the ending Y coordinate is obtained by multiplying the original ending Y coordinate by a vertical multiplying factor in step ST36. Then, a new starting X coordinate is obtained by adding the amount of transfer from the X coordinate of an item or date selected in step S31 to the X coordinate of an optional or predetermined position specified in step ST32 to the starting X coordinate multiplied by the horizontal multiplying factor. A new starting Y coordinate is obtained by adding the amount of transfer from the Y coordinate of an item or date selected in step S31 to the Y coordinate of an optional or predetermined position specified in step ST32 to the starting Y coordinate multiplied by the vertical multiplying factor. A new ending X coordinate is obtained by adding the amount of transfer from the X coordinate of an item or date selected in step S31 to the X coordinate of an optional or predetermined position specified in step ST32 to the ending X coordinate multiplied by the horizontal multiplying factor. A new ending Y coordinate is obtained by adding the amount of transfer from the Y coordinate of an item or date selected in step S31 to the Y coordinate of an optional or predetermined position specified in step ST32 to the ending Y coordinate multiplied by the vertical multiplying factor.

Back in FIG. 8D, the processes in step ST9 and the subsequent steps including the item display routine are the same as those according to the above described first embodiment of the present invention. Therefore, the detailed explanation about the processes are omitted here.

Consequently, according to the fourth embodiment of the present invention, an item or date can be displayed at an optional or predetermined position of the screen only by selecting a specified item or date. Therefore, the user of the schedule chart can easily access a target item or date displayed on the screen without scrolling the screen.

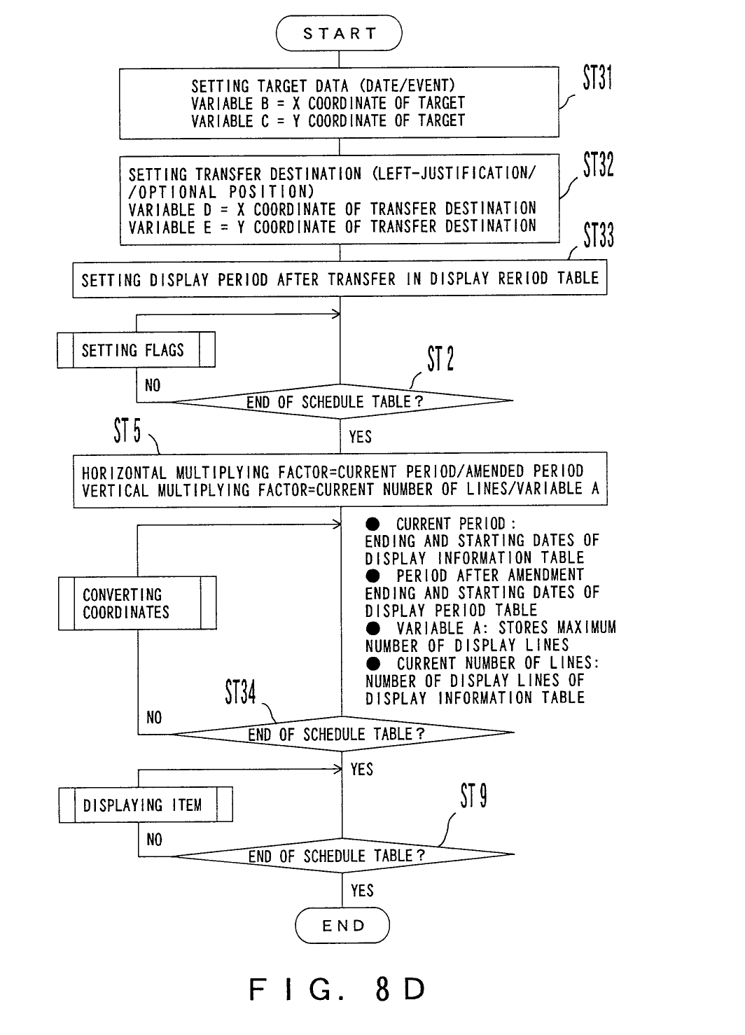

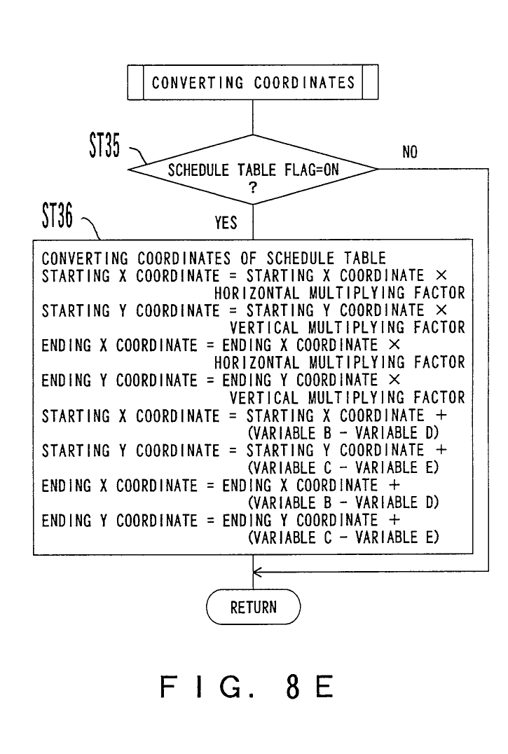

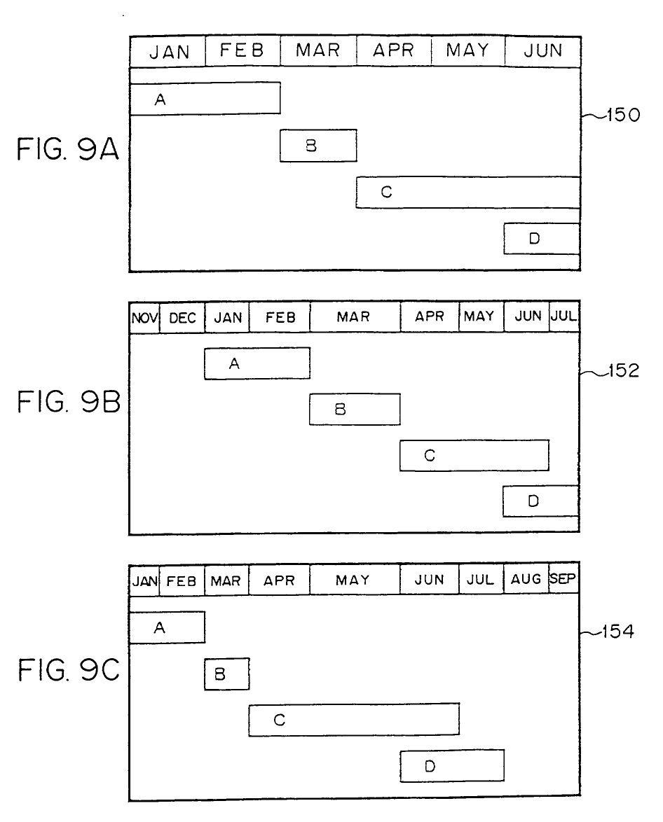

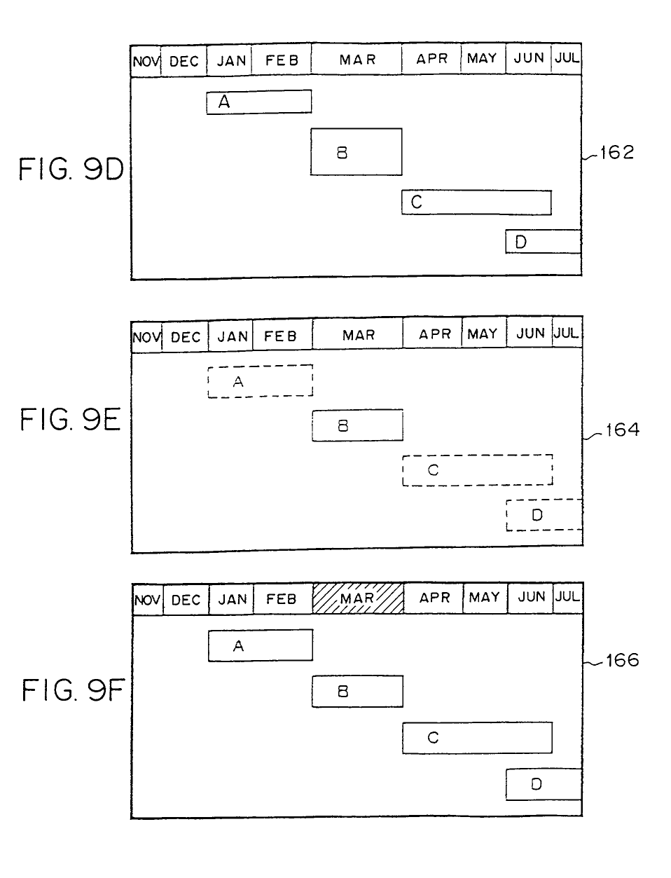

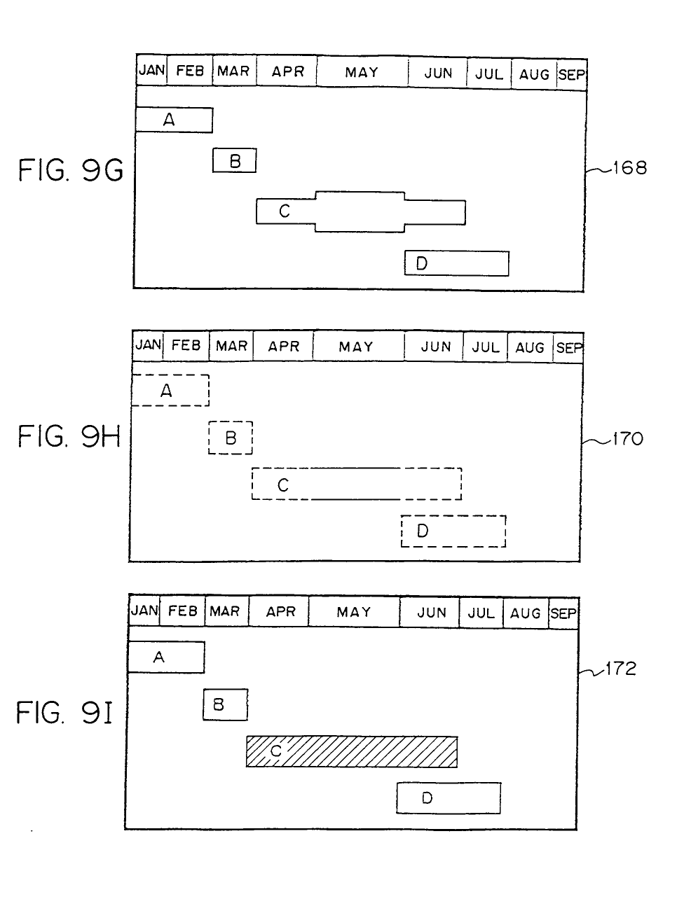

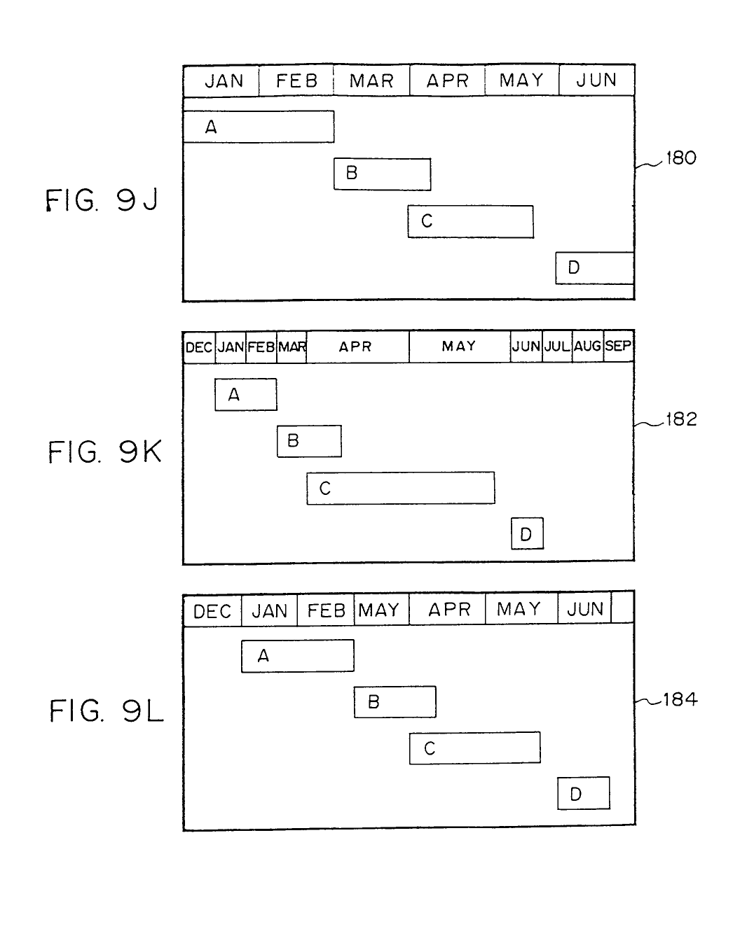

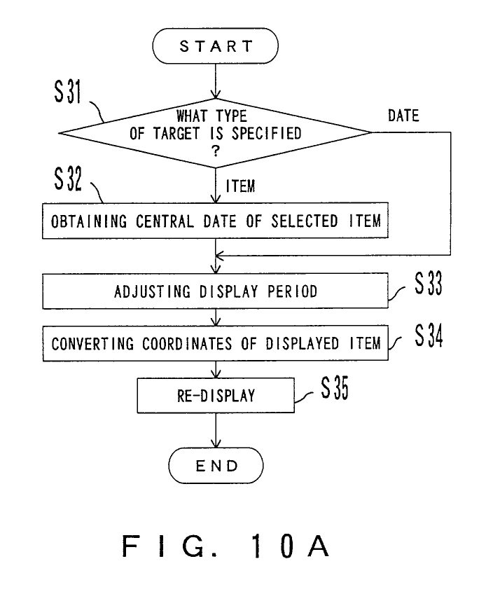

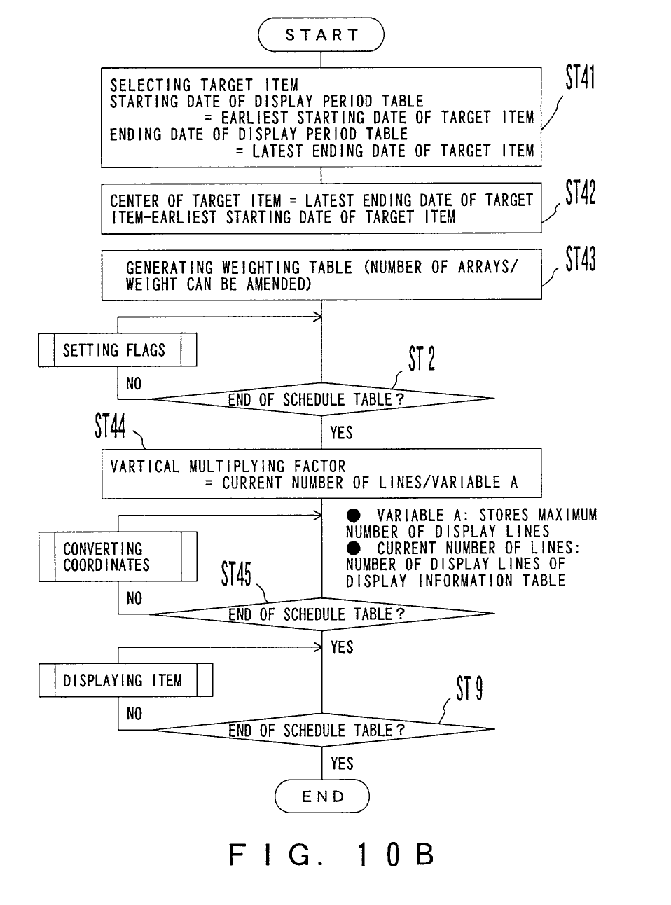

FIGS. 9A, 9B, 9C, 9D, 9E, 9F, 9G, 9H, 9I, 9J, 9K, and 9L show examples of the display after scaling up a target for display according to the fifth embodiment of the present invention.

With the schedule chart 150 as shown in FIG. 9A displayed on the display device 3, it is assumed that the schedule information about, for example, a specified target item B or a specified target period (for example, May) is confirmed, and the general information about the schedule before and after the target objects is confirmed.

In this case, a scaled-up target display menu or a button (not shown in the drawings), which indicates that a specified item or period is to be scaled up and displayed as larger than other items or periods, is selected on the screen to enter a scaled-up target display mode. Then, a target (item B) or a period (May) to be scaled up is input through the input device 2. The period ‘May’ can be replaced with any date from May 1 through 31.

The scaled-up target display specification unit 14 writes the item B into the item name column in the input data table 20 when the item B is selected and input thorough the input device 2.

The scaled-up target display adjustment unit 33 detects the item name in the input data table 20, adjusts the display intervals of a unit period in the display period such that the period containing the item can be displayed as larger than other periods, and such that the farther from a target display period is, the smaller other periods can be displayed, and transfers the process result to the coordinate converting unit 40.

The coordinate converting unit 40 converts the display coordinates of each item in the schedule chart based on the size of the display screen of the display device 3 and the display intervals of each unit period, and writes to the coordinate conversion table 50 the starting and ending coordinates on the screen for re-display. Thus, as shown in FIG. 9B, the display process unit 70 re-displays on the display device 3 according to the coordinate conversion table 50 the schedule chart 152 whose display period has been adjusted such that the period containing the item B can be displayed as larger than other periods.

When a period (for example, May), not an item, is specified as a scaled-up display target, a schedule chart 154 in which ‘May’ is displayed as larger than other periods is re-displayed on the display device 3 in the similar processes as shown in FIG. 9C. As a special case of a period, a date (for example, May 1) can be specified. In this case, the display intervals of the unit period can be adjusted such that the unit period (May) containing the date (May 1) can be displayed as larger than other periods. Otherwise, the display period can be adjusted such that the display intervals of the unit period can be the longest at the center, that is, May 1, and can be shorter toward the ends.

FIG. 9D shows an example of the display of the schedule table 162 when the specified item B is scaled up not only in the horizontal direction, but also in the vertical direction.

In FIG. 9D, the item B is scaled up not only in the horizontal direction, but also in the vertical direction. Other items are scaled down not only in the horizontal direction but also in the vertical direction.

FIG. 9E shows an example of the display of the schedule table 164 when the specified item B is not only scaled up but also emphasized.

In FIG. 9E, the item B is displayed as emphasized by a different color, brightness, contrast, etc. from those of other items.

FIG. 9F shows an example of the display of the schedule table 166 when the specified item B is not only scaled up but also emphasized for the corresponding display period.

In FIG. 9F, the display period of the item B, that is, May, is emphasized for display by a different color, brightness, contrast, etc. from those of other periods.

FIG. 9G shows an example of the display of the schedule table 168 when the specified period, that is, May, is scaled up also in the vertical direction.

In FIG. 9G, the portion displayed in the area of May is scaled up not only in the horizontal direction but also in the vertical direction. Other areas are scaled down not only in the horizontal direction but also in the vertical direction.

FIG. 9H shows an example of the display of the schedule table 170 when the specified period, that is, May, is not only scaled up but also emphasized for display.

In FIG. 9H, the portion displayed in the area of May is emphasized for display by a different color, brightness, contrast, etc. from those of other areas.

FIG. 9I shows an example of the display of the schedule table 172 when not only the specified period, that is, May, is scaled up, but also the items displayed in the specified period are emphasized for display.

In FIG. 9I, the item C, displayed in the area of the specified May, is emphasized for display by a different color, brightness, contrast, etc. from those of the items not displayed in the area of the specified May.

FIGS. 9K and 9L show examples of the display of the schedule tables 182, 184, when the schedule information is confirmed by checking the specified target period in the schedule table 180 shown in FIG. 9J, that is, April and May, and the outline of the schedule before and the after the target periods is also confirmed.

In FIG. 9K, the specified target item C is scaled up together with the corresponding period ‘April’ and ‘May’ around the center of the screen. Other periods are scaled down.

In FIG. 9L, the specified targets April and May are displayed as is, and the other periods are scaled down.

In these examples, a target date, period, or item is input after selecting the scaled-up target display mode. An instruction to scale up and display the target can also be input after a specified target is first input.

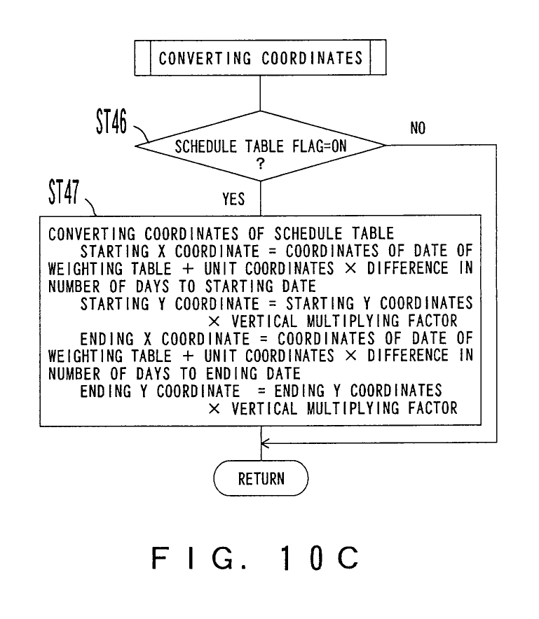

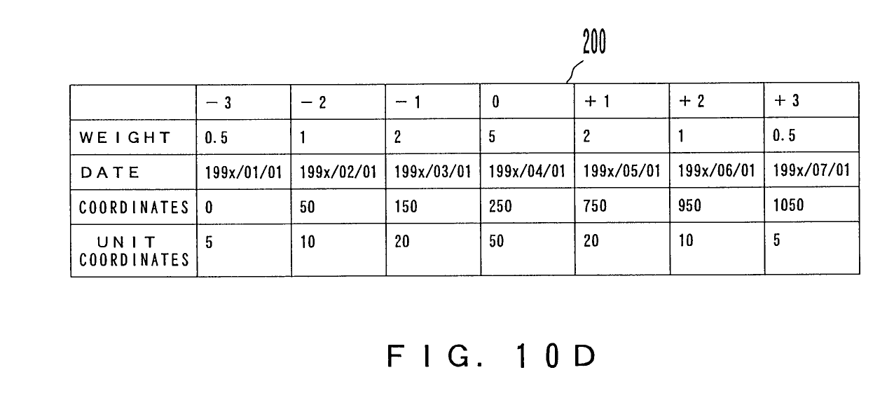

FIG. 10A is a flowchart showing the automatic adjustment process for scaling up a target to be specified for display.

The scaled up target display adjustment unit 33 determines what a specified target is by referring to the input data table 20 (S31). If the specified target is an item, the scaled-up target display adjustment unit 33 obtains the central date of the item from the schedule table 60 (S32). If a date (or period) is specified, control is passed to step S33.

Then, the display of the period containing the obtained date is set larger than the displays of other periods. The periods before and after the target period are set gradually smaller, and the result is transferred to the coordinate converting unit 40 (S33).

The coordinate converting unit 40 converts the coordinates of the item to be displayed, and writes them to the coordinate conversion table 50 (S34). The display process unit 70 re-displays the schedule chart according to the information in the coordinate conversion table 50 (S35).

Thus, a target period or item is not processed as one of a series of periods or items, and a schedule chart is displayed in such a way that a long schedule can be easily recognized.

FIGS. 10B and 10C are flowcharts showing the process of scaling up a target for display by selecting an item or period according to the fifth embodiment of the present invention. Particularly, they are flowcharts showing the process of selecting an item, scaling up or down the item in the vertical and horizontal directions, and displaying the selecting item in the center on the screen.

In step ST41 shown in FIG. 10B, the scale-up display target specification unit 14 selects a target item to be scaled up for display. The earliest date in the starting dates of selected items is defined as the starting date of the display period table 80, and the latest date in the ending dates of selected items is defined as the ending date of the display period table 80.

In step ST42, the center of the target item to be displayed can be obtained by subtracting the earliest starting date in the starting dates of the selected items from the latest ending date in the ending dates of the selected items.

In step ST43, a weighting table 200 as shown in FIG. 10D is generated. This weighting table 200 indicates a weight value in the period column, and manages the information for use in scaling up and displaying a period by referring to the weight value such that the larger the weight value is, the more the period is scaled up.

The next step ST2 and the flag setting routine are the same as those according to the first embodiment of the present invention, and the detailed explanation is omitted here.

In step ST44, the number of indication lines of the display information table 90 is divided by the variable A to obtain a vertical multiplying factor.

In step ST45, the process is performed until the last item in the schedule table 60 is processed in the loop of the redisplayed item coordinate conversion routine.

FIG. 10C shows the conversion of coordinates.

In step ST46, it is determined whether or not the flag of the item in the schedule table 60 is set ON.

If the flag is set ON, a value obtained by multiplying a coordinate in the weight table by the number of days from the starting date is added to the coordinate of the date of the weight table to obtain the starting X coordinate in step ST47. Then, the starting Y coordinate is multiplied by the vertical multiplying factor to obtain a new starting Y coordinate. A value obtained by multiplying a coordinate in the weight table by the number of days from the ending date is added to the coordinate of the date of the weight table to obtain the ending X coordinate. Then, the ending Y coordinate is multiplied by the vertical multiplying factor to obtain a new ending Y coordinate.

Back in FIG. 10B, the processes in step ST9 and the subsequent steps including the item display routine are the same as those according to the above described first embodiment of the present invention. Therefore, the detailed explanation about the processes are omitted here.

Consequently, according to the fifth embodiment of the present invention, a target item and period can be displayed as emphasized out of other items and periods. Since other items and periods can be displayed as general information, target items and periods can be easily recognized and even a long schedule can be easily understood.

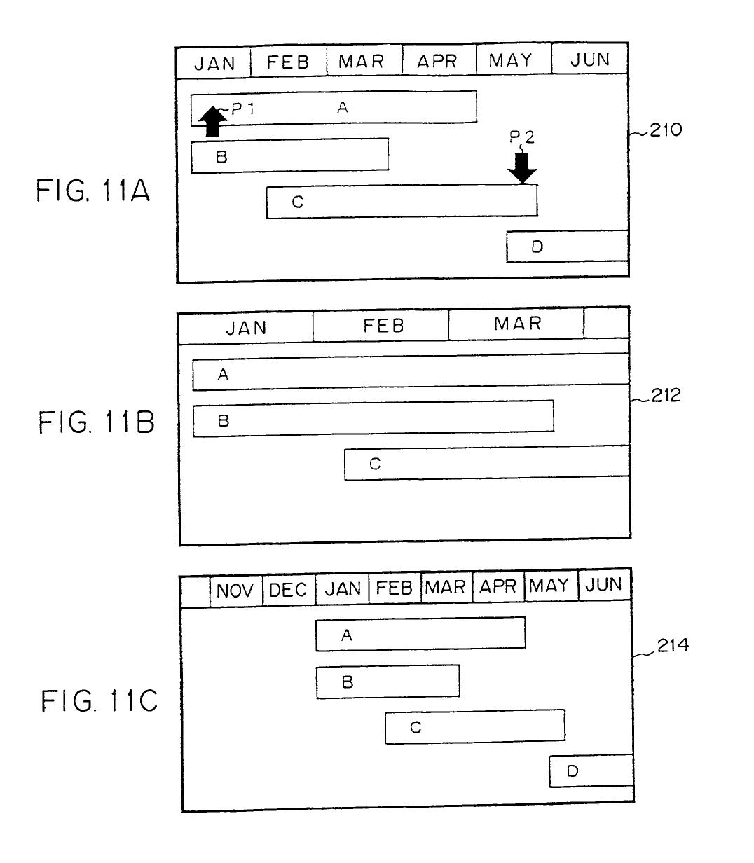

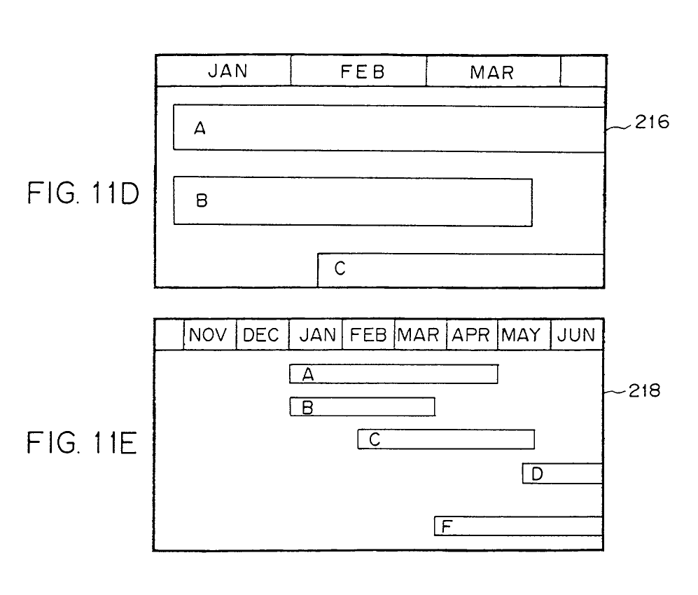

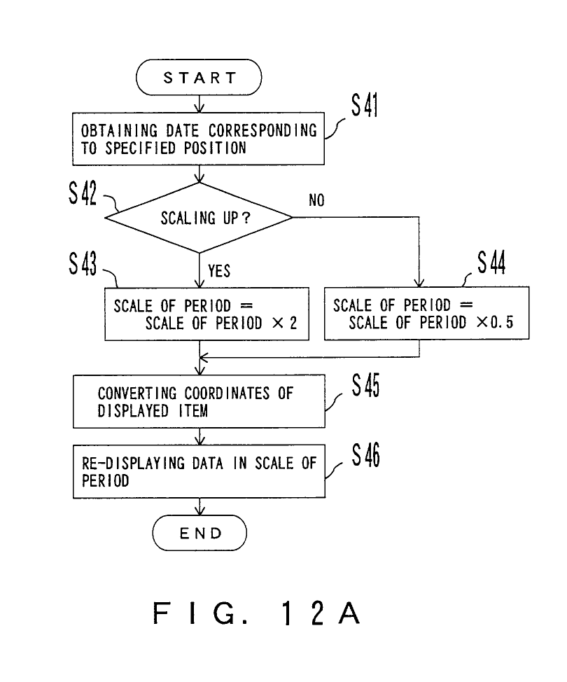

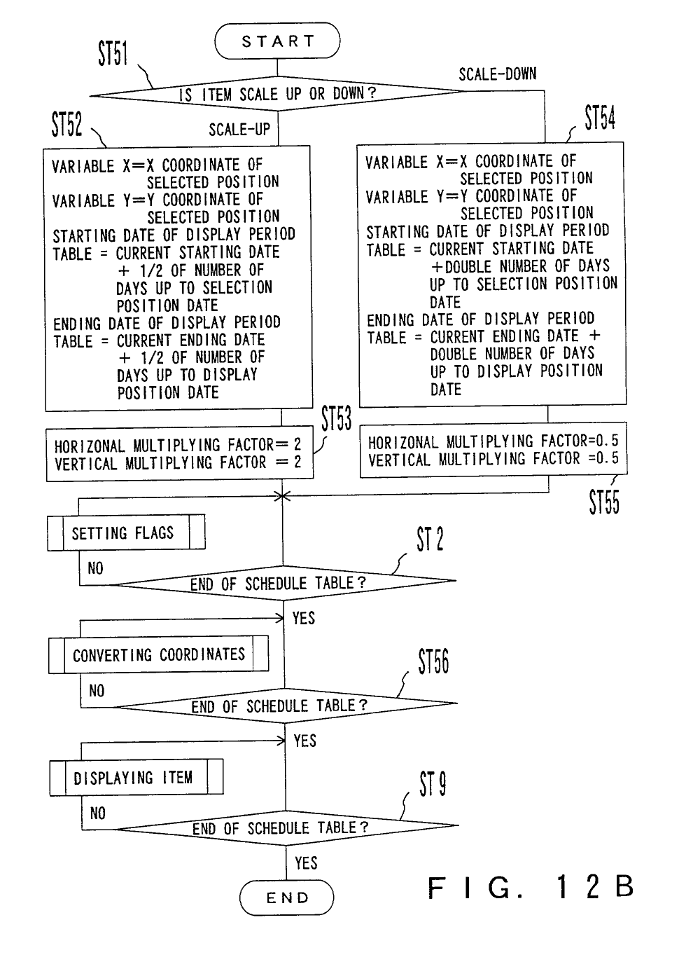

FIGS. 11A, 11B, 11C, 11D, and 11E show examples of the display after scaling up or down based on a specified position according to the sixth embodiment the present invention.

For example, based on the reference position of the schedule chart, it may be requested that a schedule before and after the position can be displayed as larger, or a schedule before a specified position can be displayed for a long period.

When a schedule chart 210 as shown in FIG. 11A is displayed on the display device 3 and it is to be scaled up based on a reference position (P1), a menu or button (not shown in the attached drawings) which indicates that a selected portion is to be scaled up at a predetermined factor is selected on the screen to enter a mode in which a specified position is scaled up. Then, the specified position P1 is input through the input device 2.

The scale-up/scale-down position specification unit 15 writes the date corresponding to the specified position into the selection date column of the input data table 20 when a selected position is input through the input device 2.

The specified position scale-up/scale-down unit 34 detects the date of the input data table 20, for example, doubles the scale of a period, sets the starting and ending dates of the display period, and transfers the process result to the coordinate converting unit 40.

The coordinate converting unit 40 converts the display coordinates of each item in the schedule chart, and writes to the coordinate conversion table 50 the starting and ending coordinates on the screen for re-display. Thus, the display process unit 70 re-displays a schedule chart 212 with the periods before and after the specified reference position P1 scaled up on the display device 3 based on the coordinate conversion table 50 as shown in FIG. 11B.

Similarly, when the schedule chart as shown in FIG. 11A is displayed on the display device 3 and a specified position is to be scaled down based on a reference position (P2), a menu or button (not shown in the attached drawings) which indicates that a selected portion is to be scaled down at a predetermined factor is selected on the screen to enter a mode in which a specified position is scaled down. Then, the specified position P2 is input through the input device 2.

The scale-up/scale-down position specification unit 15 writes the date corresponding to the specified position into the selection date column of the input data table 20 when a selected position is input through the input device 2.

The specified position scale-up/scale-down unit 34 detects the date of the input data table 20, for example, halves the scale of a period, sets the starting and ending dates of the display period, and transfers the process result to the coordinate converting unit 40.

The coordinate converting unit 40 converts the display coordinates of each item in the schedule chart, and writes to the coordinate conversion table 50 the starting and ending coordinates on the screen for re-display. Thus, the display process unit 70 re-displays a schedule chart 214 with the periods before and after the specified reference position P2 scaled up on the display device 3 based on the coordinate conversion table 50 as shown in FIG. 11C.

FIG. 11D shows an example of the display when a schedule chart 210 as shown in FIG. 11A is displayed on the display device 3 and the table is scaled up in the vertical and horizontal directions based on a reference position (P1).

FIG. 11E shows an example of the display when a schedule chart 210 as shown in FIG. 11A is displayed on the display device 3 and the table is scaled down in the vertical and horizontal directions based on a reference position (P2).

Thus, schedules before and after a certain reference position in a schedule chart can be scaled up or displayed for a long period based on the reference position.

In these examples, a specified position scale-up/scale-down display mode is first selected, and then the specified position is input. On the other hand, a specified position can be first input, and then a specified position scale-up/scale-down display instruction can be input.

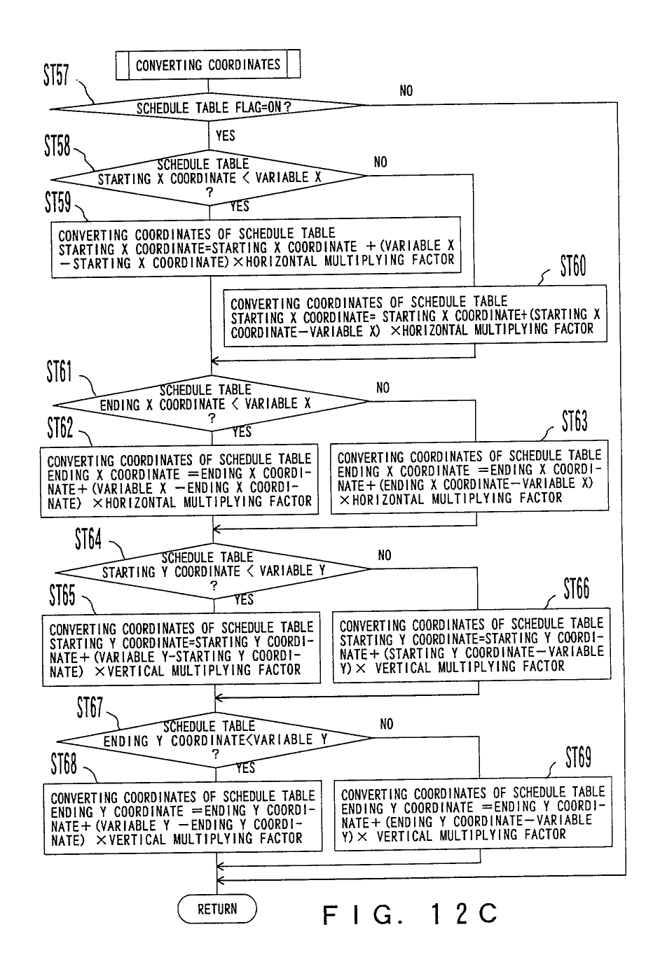

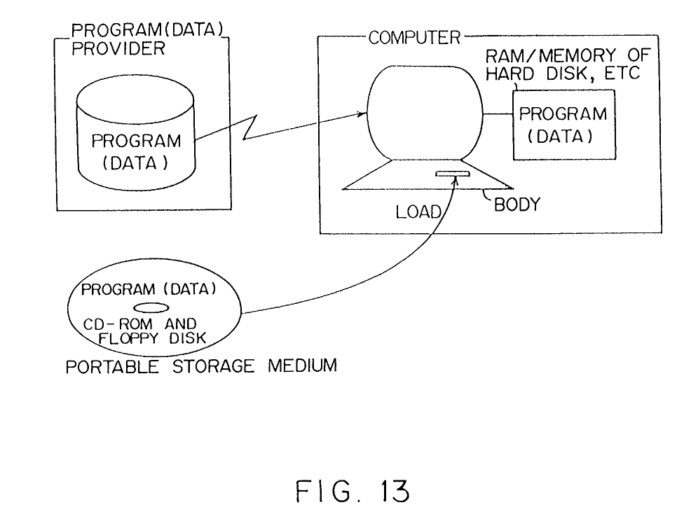

FIG. 12A is a flowchart showing the process of scaling up or down a specified position.

The specified position scale-up/scale-down unit 34 retrieves the date corresponding to the specified position on the screen from the input data table 20 (S41). Then, in the specified position scale-up/scale-down display mode, it is determined whether a specified position is to be scaled up or down (S42). When it is scaled up, the scale of a period is computed by the equation ‘period scale=period scale×2’, and the result is transferred to the coordinate converting unit 40 (S43). When it is scaled down, the scale of a period is computed by the equation ‘period scale=period scale×0.5’, and the result is transferred to the coordinate converting unit 40 (S44).

The coordinate converting unit 40 converts the coordinates of a displayed item and writes them to the coordinate conversion table 50 (S45). The display process unit 70 re-displays a schedule chart according to the information in the coordinate conversion table 50 (S46).

FIGS. 12B and 12C are flowcharts showing the process of scaling up or down an object at a specified position according to the sixth embodiment of the present invention. Particularly, they are flowcharts showing the process performed when an item is scaled up or down in the vertical and horizontal directions.

In step ST51 shown in FIG. 12B, it is determined which is entered, a specified position scale-up mode or a specified position scale-down mode.

In the specified position scale-up mode, the following processes are performed in step ST52. That is, the X coordinate of a selected position is set as a variable X. The Y coordinate of a selected position is set as a variable Y. A value obtained by multiplying the number of days from the current starting date to the date corresponding to the selected position by 0.5 is added to the value of the date of the current starting date. The result is set as a starting date of the display period table 80. A value obtained by multiplying the number of days from the current ending date to the date corresponding to the selected position by 0.5 is added to the value of the date of the current ending date. The result is set as a ending date of the display period table 80. Then, in step ST53, the horizontal multiplying factor is set to 2, and the vertical multiplying factor is set to 2.

In the specified position scale-down mode, the following processes are performed in step ST54. That is, the X coordinate of a selected position is set as a variable X. The Y coordinate of a selected position is set as a variable Y. A value obtained by multiplying the number of days from the current starting date to the date corresponding to the selected position by 2 is added to the value of the date of the current starting date. The result is set as a starting date of the display period table 80. A value obtained by multiplying the number of days from the current ending date to the date corresponding to the selected position by 2 is added to the value of the date of the current ending date. The result is set as a ending date of the display period table 80. Then, in step ST55, the horizontal multiplying factor is set to 0.5, and the vertical multiplying factor is set to 0.5.

The next step ST2 and the flag setting routine are the same as those according to the first embodiment of the present invention, and the detailed explanation is omitted here.

In step ST56, the process is performed until the last item in the schedule table 60 is processed in the loop of the redisplayed item coordinate conversion routine.

FIG. 12C shows the conversion of coordinates.

In step ST57, it is determined whether or not the flag of the item in the schedule table 60 is set ON.

If the flag is set ON, it is determined in step ST58 whether or not the variable X is larger than the starting X coordinate of the schedule table 60.

If the variable X is larger, the following processes are performed in step ST59. That is, a value obtained by subtracting the starting X coordinate from the variable X is multiplied by a horizontal multiplying factor. The result is added to the starting X coordinate to obtain a new starting X coordinate.

If the variable X is smaller, the following processes are performed in step ST60. That is, a value obtained by subtracting the variable X from the starting X coordinate is multiplied by a horizontal multiplying factor. The result is added to the starting X coordinate to obtain a new starting X coordinate.

Then, it is determined in step ST61 whether or not the variable X is larger than the ending X coordinate of the schedule table 60.

If the variable X is larger, the following processes are performed in step ST62. That is, a value obtained by subtracting the ending X coordinate from the variable X is multiplied by a horizontal multiplying factor. The result is added to the ending X coordinate to obtain a new ending X coordinate.

If the variable X is smaller, the following processes are performed in step ST63. That is, a value obtained by subtracting the variable X from the ending X coordinate is multiplied by a horizontal multiplying factor. The result is added to the ending X coordinate to obtain a new ending X coordinate.

Next, it is determined in step ST64 whether or not the variable Y is larger than the starting Y coordinate of the schedule table 60.

If the variable Y is larger, the following processes are performed in step ST65. That is, a value obtained by subtracting the starting Y coordinate from the variable Y is multiplied by a vertical multiplying factor. The result is added to the starting Y coordinate to obtain a new starting Y coordinate.

If the variable Y is smaller, the following processes are performed in step ST66. That is, a value obtained by subtracting the variable Y from the starting Y coordinate is multiplied by a vertical multiplying factor. The result is added to the starting Y coordinate to obtain a new starting Y coordinate.

Then, it is determined in step ST67 whether or not the variable Y is larger than the ending Y coordinate of the schedule table 60.

If the variable Y is larger, the following processes are performed in step ST68. That is, a value obtained by subtracting the ending Y coordinate from the variable Y is multiplied by a vertical multiplying factor. The result is added to the ending Y coordinate to obtain a new ending Y coordinate.

If the variable Y is smaller, the following processes are performed in step ST69. That is, a value obtained by subtracting the variable Y from the ending Y coordinate is multiplied by a vertical multiplying factor. The result is added to the ending Y coordinate to obtain a new ending Y coordinate.

Back in FIG. 12B, the processes in and after step ST9, including the item display routine, are the same as those according to the first embodiment of the present invention, the detailed explanation is omitted here.

In the examples above, the 2-time scale-up and the 0.5-time scale-down are described. However, it is obvious that the multiplying factor can be 3, 0.3, or any other values. That is, the multiplying factor can be any value larger than 1 for scaling up and can be any value smaller than 1 for scaling down. Furthermore, the vertical multiplying factor does not have to be equal to the horizontal multiplying factor.

Therefore, according to the sixth embodiment of the present invention, a schedule chart is scaled up based on an optional reference position of the schedule chart. Accordingly, the user can easily check the desired data including the positions before and after the reference position. Similarly, since a schedule chart is scaled up based on an optional reference position of the schedule chart, a long-term schedule can be easily displayed including a reference position.

As long as the functions according to the present invention can be performed, a single device, a system comprising a plurality of devices, an integrated device, a system for performing a process through a network such as LAN, etc. can be applicable to the present invention.

As shown in FIG. 13, the present invention can be attained by providing a system or a device with a storage medium which stores a program code of the software for realizing the functions according to each of the above described embodiments, and by a computer in the system or the device reading the program code stored in the storage medium.

In this case, the program code itself read from the storage medium performs the new function of the present invention. Therefore, the storage medium storing the program code forms part of the present invention.

The storage medium for providing a program code can be, for example, a floppy disk, a hard disk, an optical disk, a magneto-optic disk, CD-ROM (compact disk read only memory), a CD-R (compact disk rewritable), a magnetic tape, a non-volatile memory card, ROM, various storage media storing data through a network using electronic mail, personal computers, etc. (that is, communications circuits).

Additionally, the above described functions according to each of the embodiments of the present invention can be performed by executing a program code read by a computer. According to an instruction in the program code, a portion or all of an actual process is performed by an OS, etc. operating in the computer. This process can also realize the functions according to each of the embodiments of the present invention.

Furthermore, after a program code read from a storage medium is written to the memory in a function-extended board inserted to a computer or in a function-extended unit connected the computer, a CPU, etc. provided in the function-extended board or the function-extended unit performs a portion or all of an actual process. This process can also realize the above described functions according to the embodiments of the present invention.

As described above, according to the present invention, the user of a schedule chart can automatically scale up or down a schedule chart for display based on the size of the screen, or scale up a target item, etc. in the center, at an optional or predetermined position on the screen to easily check desired data only by selecting the target item or date. Thus, the user is free of the conventionally required laborious processes for scrolling and scaling up or down the screen, thereby improving the efficiency of the entire system.

What is claimed is:

1. A schedule management apparatus which displays an item to be scheduled based on a display period in a schedule chart, comprising:
target item selecting means for selecting one or more target items; and
scaling means for automatically scaling the display period based on a size of a screen such that all selected items can be completely displayed on the screen.

2. A schedule management apparatus which displays an item to be scheduled based on a display period in a schedule chart, comprising:
specifying means for specifying a start and an end of the display period; and
display period scaling means for automatically scaling the display period based on a size of a screen such that the specified display period can be completely displayed from the start to the end on the screen.

3. A schedule management apparatus which displays an item to be scheduled based on a display period in a schedule chart, comprising:
specifying means for specifying one of a current date, an optional date, and an item; and
adjusting means for adjusting a start and an end of a period to be displayed such that the specified current date, optional date, or item can be displayed in a center of the display period.

4. A schedule management apparatus which displays an item to be scheduled based on a display period in a schedule chart, comprising:
specifying means for specifying one or a target date, period, and item; and
adjusting means for adjusting display intervals of a unit period in the display period such that a period containing the specified date, the specified period, or a period containing the specified item can be longer than other periods.

5. A schedule management apparatus which displays an item to be scheduled based on a display period in a schedule chart, comprising:
specifying means for specifying a position in a displayed schedule chart; and
scaling up/scaling down means for scaling up or down the display period based on the specified position.

6. A schedule management apparatus which displays an item to be scheduled based on a display period in a schedule chart, comprising:
input process means for selecting an object specified by an input device; and
scale computing means for computing a scale to re-display the schedule chart according to information about the object selected by said input process means.

7. The apparatus according to claim 6 wherein:
said input process means comprises item selection means for selecting the item specified by the input device; and
said scale computing means comprises display period scaling means for computing a scale such that the display period spans from a start to an end of the item selected by said item selection means.

8. The apparatus according to claim 6 wherein:
said input process means comprises display period selection means for selecting the display period specified by the input device; and
said scale computing means comprises display period scaling means for computing a scale such that the display period spans from a start to an end of the display period selected by said display period selection means.

9. The apparatus according to claim 6 wherein:
said input process means comprises central display target specification means for specifying the object specified by the input device as an object to be displayed in a center of a screen; and
said scale computing means comprises central display adjustment means for computing a scale such that the object specified by said display period selection means can be displayed in the center of the screen.

10. The apparatus according to claim 9 wherein:
said central display target specification means specifies an item to be displayed in the center of the screen; and
said central display adjustment means computes a scale such that the item can be displayed in the center of the screen.

11. The apparatus according to claim 9 wherein:
said central display target specification means specifies a date to be displayed in the center of the screen; and
said central display adjustment means computes a scale such that the date can be displayed in the center of the screen.

12. The apparatus according to claim 11 wherein:
said central display target specification means specifies a current date to be displayed in the center of the screen; and
said central display adjustment means computes a scale such that said current date can be displayed in the center of the screen.

13. The apparatus according to claim 11 wherein:
said input process means comprises scale-up display target specification means for specifying the object specified by the input device as an object to be emphasized more than other objects; and
said scale computing means comprises target scale-up display adjustment means for computing a scale such that the object specified by said scale-up display target specification means can be displayed as emphasized more than other objects.

14. The apparatus according to claim 13 wherein:
said target scale-up display adjustment means scales up the specified object, and scales down the other objects.

15. The apparatus according to claim 14 wherein:
the specified object and the other objects are items.

16. The apparatus according to claim 14 wherein:
the specified object and the other objects are display periods.

17. The apparatus according to claim 6 wherein:
said input process means comprises scale-up/scale-down position specification means for specifying the object specified by the input device as a reference position in the schedule chart to be scaled up or down; and
said scale computing means comprises specified position scale-up/scale-down means for computing a scale such that the schedule chart can be scaled up or down based on the position specified by said scale-up/scale-down position specification means.

18. The apparatus according to claim 6 wherein:
said input process means comprises optional/predetermined position display target specification means for specifying the object specified by the input device as an object to be displayed at an optional or predetermined position; and
said scale computing means comprises optional/predetermined position display adjustment means for computing a scale such that the object specified by said display period selection means can be displayed at an optional or predetermined position.

19. The apparatus according to claim 18 wherein:
said optional/predetermined position display target specification means specifies an item as an object to be displayed at an optional or predetermined position; and
said optional/predetermined position display adjustment means computes a scale such that the item can be displayed at an optional or predetermined position.

20. The apparatus according to claim 18 wherein:
said optional/predetermined position display target specification means specifies a date as an object to be displayed at an optional or predetermined position; and
said optional/predetermined position display adjustment means computes a scale such that the date can be displayed in the center of the screen.

21. The apparatus according to claim 20 wherein:
said optional/predetermined position display target specification means specifies a current date as an optional date to be displayed at an optional or predetermined position; and
said optional/predetermined position display adjustment means computes a scale such that the current date can be displayed at an optional or predetermined position.

22. A method of managing a schedule for displaying an item to be scheduled based on a display period in a schedule chart, comprising the steps of:
selecting an object specified by an input device; and
computing a scale for re-displaying the schedule chart according to information about the selected object.

23. A computer-readable storage medium storing a process for realizing a schedule management apparatus which displays an item to be scheduled based on a display period in a schedule chart, said process comprising the steps of:
selecting one or more target items; and
automatically scaling the display period based on a size of a screen such that all selected items can be completely displayed on the screen.

24. A computer-readable storage medium storing a process for realizing a schedule management apparatus which displays an item to be scheduled based on a display period in a schedule chart, said process comprising the steps of:
specifying a start and an end of the display period; and
automatically scaling the display period based on a size of a screen such that the specified display period can be completely displayed from the start to the end on the screen.

25. A computer-readable storage medium storing a process for realizing a schedule management apparatus which displays an item to be scheduled based on a display period in a schedule chart, said process comprising the steps of:
specifying one of a current date, an optional date, and an item; and
adjusting a start and an end of a period to be displayed such that the specified current date, optional date, or item can be displayed in a center of the display period.

26. A computer-readable storage medium storing a process for realizing a schedule management apparatus which displays an item to be scheduled based on a display period in a schedule chart, said process comprising the steps of:
specifying one or a target date, period, and item; and
adjusting display intervals of a unit period in the display period such that a period containing the specified date, the specified period, or a period containing the specified item can be longer than other periods.

27. A computer-readable storage medium storing a process for realizing a schedule management apparatus which displays an item to be scheduled based on a display period in a schedule chart, said process comprising the steps of:
specifying a position in a displayed schedule chart; and
scaling up or down the display period based on the specified position.

28. A computer-readable storage medium storing a process for realizing a schedule management apparatus which displays an item to be scheduled based on a display period in a schedule chart, said process comprising the steps of:
selecting an object specified by an input device; and
computing a scale for re-displaying a schedule chart according to information about the selected object.
